(19) United States
(12) Patent Application Publication
(10) Pub. No.: US 2015/0006528 A1
(43) Pub. Date: Jan. 1, 2015

(54) Hierarchical data structure of documents

(71) Applicant: IAC Search & Media, Inc., Oakland, CA (US)

(72) Inventors: Vaijanath N. Rao, Sausalito, CA (US); Bhawna SINGH, Fremont, CA (US); Suraj Sunil SONI, Fremont, CA (US); Chachi KRUEL, Salt Lake City, UT (US)

(73) Assignee: IAC Search & Media, Inc., Oakland, CA (US)

(21) Appl. No.: 14/316,611

(22) Filed: Jun. 26, 2014

Related U.S. Application Data
(60) Provisional application No. 61/840,781, filed on Jun. 28, 2013.
(60) Provisional application No. 61/846,838, filed on Jul. 16, 2013.
(60) Provisional application No. 61/856,572, filed on Jul. 19, 2013.
(60) Provisional application No. 61/860,515, filed on Jul. 31, 2013.

(51) Int. Cl. G06F 17/30

(52) U.S. Cl. CPC G06F 17/30867; G06F 17/30705; G06F 17/30327; G06F 17/30616
USPC 707/730; 707/739; 707/797

(57) ABSTRACT

A method of processing data is described. A set of documents is stored in a data store. A hierarchical data structure is created based on concepts within the documents. The hierarchical data structure's generated by generating phrases from the documents, initiating clustering of the phrases by entering respective documents into each of a plurality of slots, wherein only one result is entered for multiple documents that are similar, clustering the documents for each slot by creating trees with respective nodes representing the documents that are similar, and labeling each tree by determining a concept of each tree and its nodes. Once labeling is completed, a sentence summarizer and sentence filtering and scoring are applied to create summary sentences and scores.

### CROSS-REFERENCE TO RELATED APPLICATIONS

This application claims priority from U.S. Provisional Patent Application No. 61/840,781, filed on Jun. 28, 2013; U.S. Provisional Patent Application No. 61/846,838, filed on Jul. 16, 2013; U.S. Provisional Patent Application No. 61/856,572, filed on Jul. 19, 2013 and U.S. Provisional Patent Application No. 61/860,515, filed on Jul. 31, 2013, each of which is incorporated herein by reference in their entirety.

### BACKGROUND OF THE INVENTION

1). Field of the Invention

This invention relates generally to a method of processing data, and more specifically to the processing of data within a search engine system.

2). Discussion of Related Art

Search engines are often used to identify remote websites that may be of interest to a user. A user at a user computer system types a query into a search engine interface and transmits the query to the search engine. The search engine has a search engine data store that holds information regarding the remote websites. The search engine obtains the data of the remote websites by periodically crawling the Internet. A data store of the search engine includes a corpus of documents that can be used for results that the search engine then transmits back to the user computer system in response to the query.

### SUMMARY OF THE INVENTION

The invention provides a method of processing data including storing a set of documents in a data store and generating a hierarchical data structure based on concepts within the documents.

The method may further include that the hierarchical data structure is generated according to a method including generating phrases from the documents, initiating clustering of the phrases by entering respective documents into each of a plurality of slots, wherein only one documents is entered from multiple documents that are similar, clustering the documents of each slot by creating tree with respective nodes representing the documents that are similar and labeling each tree by determining a concept of each tree.

The method may further include that the phrases include at least uni-grams, bi-grams and tri-grams.

The method may further include that the phrases are extracted from text in the documents.

The method may further include expanding a number of the slots when all the slots are full.

The method may further include that the clustering of the documents includes determining whether a document is to be added to an existing cluster, if the document is to be added to a new cluster, creating a new node representing the document, following the creation of the new node, determining whether the new node should be added as a child node, if the determination is made that the new document should be added as a child node, connecting the document as a child of the parent, if the determination is made that the new node should not be added as a child node, swapping the parent and child nodes, if the determination is made that the new document should not be added to an existing cluster, then creating a new cluster, following the connection to the parent, the swapping of the parent and child nodes, or the creation of the new cluster, making a determination whether all documents have been updated, if all documents have not been updated, then picking a new document for clustering and if a determination is made that all documents are updated, then making a determination that an update of the documents is completed.

The method may further include that the clustering includes determining a significance of each one of the trees.

The method may further include that the clustering includes traversing a tree from its root, removing a node from the tree, determining whether a parent without a sub-tree that includes the node has a score that is significantly less than a score of the tree before the sub-tree is removed, if the determination is made that the score is not significantly less, then adding the sub-tree back to the tree, if the determination is made that the score is significantly less, then dropping the sub-tree that includes the node, after the node has been added back or after dropping the sub-tree, determining whether all nodes of the tree have been processed, if all the nodes of the trees have not been processed, then removing another node from the tree and repeating the process of determining a significance and if all nodes have been processed, then making a determination that pruning is completed.

The method may further include that the clustering includes iteratively repeating the creation of the trees and pruning of the trees.

The method may further include that the labeling of each tree includes traversing through a cluster for the tree, computing a cluster confidence score for the cluster, determining whether the confidence score is lower than a threshold, if the confidence score is less than the threshold, then renaming a label for the cluster and if the confidence score is not lower than the threshold, then making a determination that scoring is completed.

The method may further include that the confidence score is based on the following five factors: a number of different sources that are included within the cluster, a length of the maximum sentence, a number of different domains, an order of ranking within the search engine database 180 and a number of occurrences.

The method may further include that the labeling further include traversing nodes of each tree comprising a cluster, identifying a node label for each node, comparing the node label with a parent label of a parent node in the tree for the cluster, determining whether the parent label is the same as the node label, if the determination is made that the parent label is not the same as the label for the node, then again identifying a node label for the node and if the determination is made that the parent label is the same as the node label, then making a determination that labeling is completed.

The method may further include receiving a query from a user computer system, wherein the generation of the hierarchical data structure is based on the query and returning documents to the user computer system based on the hierarchical data structure.

The invention also provides a computer-readable medium having stored thereon a set of data which, when executed by a processor of a computer executes a method of processing data including storing a set of documents in a data store and generating a hierarchical data structure based on concepts within the documents.

The invention provides a method of processing data including storing a set of documents in a data store, receiving a query from a user computer system, in response to the query extracting concepts within the documents that are related to the query, using the concepts extracted from the set of documents to determine an answer and returning the answer to the user computer system.

The method may further include generating a hierarchical data structure based on concepts within the documents in response to the query.

The method may further include that the hierarchical data structure is generated according to a method including generating phrases from the documents, initiating clustering of the phrases by entering respective documents into each of a plurality of slots, wherein only one documents is entered from multiple documents that are similar, clustering the documents of each slot by creating tree with respective nodes representing the documents that are similar and labeling each tree by determining a concept of each tree.

The method may further include that the phrases include at least uni-grams, bi-grams and tri-grams.

The method may further include that the phrases are extracted from text in the documents.

The method may further include expanding a number of the slots when all the slots are full.

The method may further include that the clustering of the documents includes determining whether a document is to be added to an existing cluster, if the document is to be added to a new cluster, creating a new node representing the document, following the creation of the new node, determining whether the new node should be added as a child node, if the determination is made that the new document should be added as a child node, connecting the document as a child of the parent, if the determination is made that the new node should not be added as a child node, swapping the parent and child nodes, if the determination is made that the new document should not be added to an existing cluster, then creating a new cluster, following the connection to the parent, the swapping of the parent and child nodes, or the creation of the new cluster, making a determination whether all documents have been updated, if all documents have not been updated, then picking a new document for clustering and if a determination is made that all documents are updated, then making a determination that an update of the documents is completed.

The method may further include that the clustering includes determining a significance of each one of the trees.

The method may further include that the clustering includes traversing a tree from its root, removing a node from the tree, determining whether a parent without a sub-tree that includes the node has a score that is significantly less than a score of the tree before the sub-tree is removed, if the determination is made that the score is not significantly less, then adding the sub-tree back to the tree, if the determination is made that the score is significantly less, then dropping the sub-tree that includes the node, after the node has been added back or after dropping the sub-tree, determining whether all nodes of the tree have been processed, if all the nodes of the trees have not been processed, then removing another node from the tree and repeating the process of determining a significance and if all nodes have been processed, then making a determination that pruning is completed.

The method may further include that the clustering includes iteratively repeating the creation of the trees and pruning of the trees.

The method may further include that the labeling of each tree includes traversing through a cluster for the tree, computing a cluster confidence score for the cluster, determining whether the confidence score is lower than a threshold, if the confidence score is less than the threshold, then renaming a label for the cluster and if the confidence score is not lower than the threshold, then making a determination that scoring is completed.

The method may further include that the confidence score is based on the following five factors: a number of different sources that are included within the cluster, a length of the maximum sentence, a number of different domains; an order of ranking within the search engine database 180 and a number of occurrences.

The method may further include that the labeling further includes traversing nodes of each tree comprising a cluster, identifying a node label for each node, comparing the node label with a parent label of a parent node in the tree for the cluster, determining whether the parent label is the same as the node label, if the determination is made that the parent label is not the same as the label for the node, then again identifying a node label for the node and if the determination is made that the parent label is the same as the node label, then making a determination that labeling is completed.

The method may further include limiting the set of documents to a subset of results based on the query, the concepts being determined based only on the subset of results.

The invention further provides a non-transitory computer-readable medium having stored thereon a set of data which, when executed by a processor of a computer executes a method of processing data comprising storing a set of documents in a data store, receiving a query from a user computer system, in response to the query extracting concepts within the documents that are related to the query, using the concepts extracted from the set of documents to determine an answer and returning the answer to the user computer system.

The invention provides a method of processing data including storing a set of labels and related documents in a data store, selecting a label, identifying an answer set of the set of documents based on the selected label, identifying sentences in the documents in the answer set, compiling the sentences identified from the documents in the answer set into a sentence list, the sentences that are compiled into the sentence list originating from a plurality of the documents in the answer set, determining at least one label for each one of the sentences in the sentence list, sorting the sentences in the sentence list into a sorted list of sentences by applying sort factors to the labels of the sentences in the sentence list and providing an output in response to the label, the output being based on the sorted list of sentences.

The method may further include that each sentence is identified by a period (“.”) or a question mark (“?”) at the end of the respective sentence.

The method may further include determining a plurality of concepts based on the selected label, the labels of the sentences being determined by matching the concepts to words in the sentences.

The method may further include determining synonyms for the words in the sentences, the matching of the concepts to the words including matching of the synonyms to the words.

The method may further include that the output includes the concepts.

The method may further include that the output includes a concept validation summary that includes selected ones of the sentences that match a selected one of the concepts.

The method may further include the sort factors that a count of the number of labels in each sentence and freshness of each sentence.

The method may further include determining candidate sentences in the sentence list having the selected label, wherein only the candidate sentences are sorted by applying the sort factors and the sorting results in a ranking of the sentences, determining an answer set of the sentences based on the ranking, wherein only sentences having a predetermined minimum ranking are included in the answer set and compiling a cluster summary by combining the sentences of the answer set.

The method may further include identifying a summary type to be returned, wherein the cluster summary is only compiled only if the summary type is a cluster summary type.

The method may further include determining a relevance of each sentence in the answer set, wherein only sentences that have a high relevance are included in the cluster summary.

The invention also provides a non-transitory computer-readable medium having stored thereon a set of data which, when executed by a processor of a computer executes a method of processing data including storing a set of labels and related documents in a data store, selecting a label, identifying an answer set of the set of documents based on the selected label, identifying sentences in the documents in the answer set, compiling the sentences identified from the documents in the answer set into a sentence list, the sentences that are compiled into the sentence list originating from a plurality of the documents in the answer set, determining at least one label for each one of the sentences in the sentence list, sorting the sentences in the sentence list into a sorted list of sentences by applying sort factors to the labels of the sentences in the sentence list and providing an output in response to the label, the output being based on the sorted list of sentences.

The invention also provides a method of processing data including storing a set of documents in a data store and generating a hierarchical data structure based on concepts within the documents.

The invention provides a method of determining a relevance of each of a plurality of results in a results list, including generating an entropy score for a first result in the result list, if the entropy score is above a pre-determined minimum entropy value adding the first result to a picked result list, computing a similarity score between the first result added to the picked summary list and a second result in the result list and if the similarity score is above a pre-determined minimum similarity value removing the second result from the result list.

The method may further include populating a list of results based on one concept, the result list comprising the results that have been populated in the list.

The method may further include selecting a respective result from the result list for which an entropy score has not been generated, the respective result being the first result for which the entropy score is generated, determining whether an entropy score has been generated for all results in the results list, if an entropy score has not been generated for all results in the result list then repeating the selection of a respective result from the result list for which an entropy score has not been generated, the respective result being the first result for which the entropy score is generated and if an entropy score has been generated for all results in the result list then sorting the result list based on the entropy scores of the respective results into a sorted order.

The method may further include picking each result from the top of the sorted order having the highest entropy score, the result being picked being the first result for which the determination is made whether the entropy score thereof is above the pre-determined minimum entropy value.

The method may further include removing the first result from the sorted order if the entropy score is not above the pre-determined minimum entropy value.

The method may further include that the predetermined minimum entropy value is 0.

The method may further include that the similarity score is a cosine similarity score.

The method may further include determining whether a similarity score is generated for all results in the picked summary list, if a similarity score has not been generated for all results in the picked summary list then repeating the computing of the similarity score for a next result in the picked summary list and if a similarity score has been generated for all results in the picked summary list then determining whether the similarity score is above the pre-determined minimum value.

The method may further include determining whether a similarity score for all results in the picked summary list have been checked, and if a similarity score has not been checked for all results in the picked summary list then repeating the determination of whether the similarity score is above the predetermined minimum similarity soccer until a similarity score for all results in the picked summary list have been checked.

The method may further include removing words of the first result from words in the result list and generating an entropy score for a result in the result list after the words have been removed.

The method may further include repeatedly removing words from the result list and re-generating an entropy score until there are no more results in the result list having an entropy score more than the predetermined minimum entropy value.

The method may further include selecting a respective result from the result list for which an entropy score has not been generated, the respective result being the first result for which the entropy score is generated, determining whether an entropy score has been generated for all results in the results list, if an entropy score has not been generated for all results in the result list then repeating the selection of a respective result from the result list for which an entropy score has not been generated, the respective result being the first result for which the entropy score is generated, if an entropy score has been generated for all results in the result list then sorting the result list based on the entropy scores of the respective results into a sorted order, determining whether a similarity score is generated for all results in the picked summary list, if a similarity score has not been generated for al results in the picked summary list then repeating the computing of the similarity score for a next result in the picked summary list, if a similarity score has been generated for all results in the picked summary list then determining whether the similarity score is above the pre-determined minimum value, determining whether a similarity score for all results in the picked summary list have been checked, if a similarity score has not been checked for all results in the picked summary list then repeating the determination of whether the similarity score is above the predetermined minimum similarity soccer until a similarity score for all results in the picked summary list have been checked, removing words of the first result from words in the result list; and generating an entropy score for a result in the result list after the words have been removed.

The invention further provides a non-transitory computer-readable medium having stored thereon a set of data which, when executed by a processor of a computer executes a method of determining a relevance of each of a plurality of results in a results list, including generating an entropy score for a first result in the result list, if the entropy score is above a pre-determined minimum entropy value adding the first result to a picked result list, computing a similarity score between the first result added to the picked summary list and a second result in the result list, and if the similarity score is above a pre-determined minimum similarity value removing the second result from the result list.

The invention also provides a computer-implemented method of determining relatedness, including storing, by a processor of a computing device, a reference set of documents, wherein each document has one or more concepts associated therewith, determining, by the computing device, a concept vector set and a document vector set, wherein the concept vector set includes the concepts from the reference set and at least one vector associated therewith and the document vector set includes the documents from the reference set and at least one vector associated therewith, for each of a plurality of concept pairs in the concept vector set includes determining, by the computing device, a relatedness between the concepts of the pair by calculating a similarity score of the concept vectors of the concepts of the pair, retaining, by the computing device, at least a subset of the similarity scores for the concepts having a predetermined threshold and writing, by the computing device, the relatedness for the concepts of the pair in a related concepts store, and for each of a plurality of document pairs in the document vector set includes determining, by the computing device, a relatedness between the documents of the pair by calculating a similarity score of the document vectors of the documents of the pair, retaining, by the computing device, at least a subset of the similarity scores for the document for the documents having predetermined threshold and writing, by the computing device, the relatedness for the documents of the pair in a related documents store.

The method may further include generating, by the computing device, an input set, the input set including the documents and concepts from the reference set and a random document vector represented at an intersection of each document and each concept, wherein the concept vector set and document vector set are determined by executing, by the computing device, a plurality of iteration, wherein each iteration includes emptying, by the computing device, all concept vectors for all concepts in the input set from a concept vector set, for every concept in the reference set includes determining, by the computing device, a document set that includes all the documents in the reference set in which the concept appears, obtaining, by the computing device, a concept vector input by adding the document vectors in the input set corresponding to the documents in the document set, adding, by the computing device, the concept vector input to the concept vector for the concept to the concept vector set, emptying, by the computing device, all document vectors for all documents in the input set from a document vector set, for every document in the reference set includes determining, by the computing device, a concept set that includes all the concepts in the reference set in which the document appears, obtaining, by the computing device, a document vector input by adding the concept vectors in the input set corresponding to the concepts in the concept set and adding, by the computing device, the document vector input to the document vector for the document to the document vector set.

The method may further include that each of a plurality of concept pairs in the concept vector set includes retaining, by the computing device, at least a subset of the similarity scores for the concepts having a predetermined threshold, wherein the relatedness that are retained are written in the related concepts store, and each of a plurality of document pairs in the document vector set includes retaining, by the computing device, at least a subset of the similarity scores for the documents having a predetermined threshold, wherein the relatedness that are retained are written in the related concepts store.

The method may further include that the similarity scores are calculated by a cosine similarity calculation.

The invention further provides a computer-implemented method of determining relatedness, including storing, by a processor of a computing device, a reference set of documents, wherein each document has one or more concepts associated therewith, generating, by the computing device, an input set, the input set including the documents and concepts from the reference set and a random document vector represented at an intersection of each document and each concept, executing, by the computing device, a plurality of iterations, wherein each iteration includes emptying, by the computing device, all concept vectors for all concepts in the input set from a concept vector set, for every concept in the reference set determining, by the computing device, a document set that includes all the documents in the reference set in which the concept appears, obtaining, by the computing device, a concept vector input by adding the document vectors in the input set corresponding to the documents in the document set, adding, by the computing device, the concept vector input to the concept vector for the concept to the concept vector set and emptying, by the computing device, all document vectors for all documents in the input set from a document vector set, for every document in the reference set determining, by the computing device, a concept set that includes all the concepts in the reference set in which the document appears, obtaining, by the computing device, a document vector input by adding the concept vectors in the input set corresponding to the concepts in the concept set and adding, by the computing device, the document vector input to the document vector for the document to the document vector set, for each of a plurality of concept pairs in the concept vector set determining, by the computing device, a relatedness between the concepts of the pair by calculating a similarity score of the concept vectors of the concepts of the pair, retaining, by the computing device, at least a subset of the similarity scores for the concepts having a predetermined threshold and writing, by the computing device, the relatedness for the concepts of the pair in a related concepts store, for each of a plurality of document pairs in the document vector set determining, by the computing device, a relatedness between the documents of the pair by calculating a similarity score of the document vectors of the documents of the pair, retaining, by the computing device, at least a subset of the similarity scores for the documents having a predetermined threshold and writing, by the computing device, the relatedness for the documents of the pair in a related documents store.

The invention also provides computer-readable medium having stored thereon a set of instructions which, when executed by a processor of a computer carries out a computer-implemented method of determining relatedness, including storing, by a processor of a computing device, a reference set of documents, wherein each document has one or more concepts associated therewith, generating, by the computing device, an input set, the input set including the documents and concepts from the reference set and a random document vector represented at an intersection of each document and each concept, determining, by the computing device, a concept vector set and a document vector set, wherein the concept vector set includes the concepts from the reference set and at least one vector associated therewith and the document vector set includes the documents from the reference set and at least one vector associated therewith, for each of a plurality of concept pairs in the concept vector set determining, by the computing device, a relatedness between the concepts of the pair by calculating a similarity score of the concept vectors of the concepts of the pair, retaining, by the computing device, at least a subset of the similarity scores for the concepts having a predetermined threshold and writing, by the computing device, the relatedness for the concepts of the pair in a related concepts store, for each of a plurality of document pairs in the document vector set determining, by the computing device, a relatedness between the documents of the pair by calculating a similarity score of the document vectors of the documents of the pair, retaining, by the computing device, at least a subset of the similarity scores for the documents having a predetermined threshold and writing, by the computing device, the relatedness for the documents of the pair in a related documents store.

The invention further provides a method of determining relatedness to a concept of researching, including receiving a plurality of concepts for storage and their relatedness to one another, storing a plurality of edges indexes based on the concepts for storage, wherein each edges index has a plurality of edges, wherein a first of the edges reflects a relatedness between a first of the concepts and a plurality of second ones of the concepts, wherein a second of the edges reflects a relatedness between each one of the second concepts and a plurality of third concepts related to each one of the second concepts, receiving the concept for searching, receiving a depth, searching among the edges indexes for a selected edges index having the concept for searching as the first concept and returning a number of the concepts of the selected edges indexes, wherein the number of edges for which concepts are returned are equal to the depth.

The method may further include that a third of the edges reflects a relatedness between each one of the third concepts and a plurality of fourth concepts related to each one of the third concepts.

The method may further include the depth is less than three.

The method may further include the depth is more than three, further including copying the concepts of the third edges as replacement concepts for searching, searching among the edges indexes for selected repeat edges indexes having the replacement concepts for searching as the first concept and returning a number of the concepts of the selected repeat edges indexes.

The method may further include that the number of repeat edges for which concepts are returned are equal to the depth minus three.

The method may further include storing a plurality of vertex indexes based on the concepts for storage, wherein each vertex index has a plurality of vertexes, wherein each vertex reflects a relationship between a concept acting as a primary node and a plurality of the concepts acting as secondary nodes and determining a plurality of documents based on the plurality of concepts acting as primary and secondary nodes.

The method may further include using the concepts returned based on the edges indexes to determine relevance of the documents.

The invention also provides a computer-readable medium having stored thereon a set of instructions which, when executed by a processor of a computer carries out a computer-implemented method of determining relatedness to a concept of researching, comprising receiving a plurality of concepts for storage and their relatedness to one another, storing a plurality of edges indexes based on the concepts for storage, wherein each edges index has a plurality of edges, wherein a first of the edges reflects a relatedness between a first of the concepts and a plurality of second ones of the concepts, wherein a second of the edges reflects a relatedness between each one of the second concepts and a plurality of third concepts related to each one of the second concepts, receiving the concept for searching, receiving a depth, searching among the edges indexes for a selected edges index having the concept for searching as the first concept and returning a number of the concepts of the selected edges indexes, wherein the number of edges for which concepts are returned are equal to the depth, wherein a third of the edges reflects a relatedness between each one of the third concepts and a plurality of fourth concepts related to each one of the third concepts.

### BRIEF DESCRIPTION OF THE DRAWINGS

The invention is further described by way of examples with reference to the accompanying drawings, wherein:

FIG. 1 is a block diagram of a network environment that includes a search engine in which aspects of the invention are manifested;

FIG. 2 is a flow chart illustrating a high level process flow for concept-based searching according to an embodiment of the invention;

FIG. 3 is a flow chart illustrating offline enrichment within the process flow in FIG. 2;

FIG. 4 is a flow chart illustrating online enrichment within the process flow of FIG. 2;

FIG. 5 is a flow chart illustrating concept extraction within the process flows of either FIG. 3 or 4;

FIG. 6 is a schematic view illustrating phrase generation within the flow of FIG. 5;

FIG. 7 is a schematic view illustrating cluster initialization within the flow of FIG. 5;

FIG. 8 is a flow chart showing clustering within the flow of FIG. 5;

FIGS. 9a, b and c are data structure trees that are constructed and pruned according to the process flows of FIG. 8;

FIGS. 10a to 10f show a first iteration for determining a concept vector set and a document vector set;

FIGS. 11a to 11f show a first iteration for determining a concept vector set and a document vector set;

FIG. 12 shows how the concept vector set is used to determine relatedness between concepts;

FIG. 13 shows how the document vector set is used to determine relatedness between documents;

FIG. 14 is a graph illustrating a related data component that received;

FIG. 15 illustrates code of how of one of a plurality of vertex indexes is stored;

FIG. 16 illustrates code of how one of a plurality of edges indexes is stored;

FIG. 17 is a flow chart that illustrates how the vertex indexes and the edges indexes are searched;

FIG. 18 is a flow chart showing labeling within the flow of FIG. 5;

FIG. 19 is a flow chart showing summary generation;

FIG. 20 is a screenshot of a user interface that is provided to a client computer system with sentences and summaries;

FIG. 21 is a flow chart showing relevance determination by a relevance analyzer;

FIG. 22 shows how sentences and summaries are extracted from a data store that is created offline in response to a query in an online request;

FIG. 23 is a flow chart similar to FIG. 13 showing how the relevance analyzer can be used for purposes other than sentences;

FIG. 24 is a block diagram showing the use of the relevance analyzer to provide a response following a call that is received by the relevance analyzer; and

FIG. 25 is a block diagram of a machine in the form of a computer system forming part of the network environment.

### DETAILED DESCRIPTION OF THE INVENTION

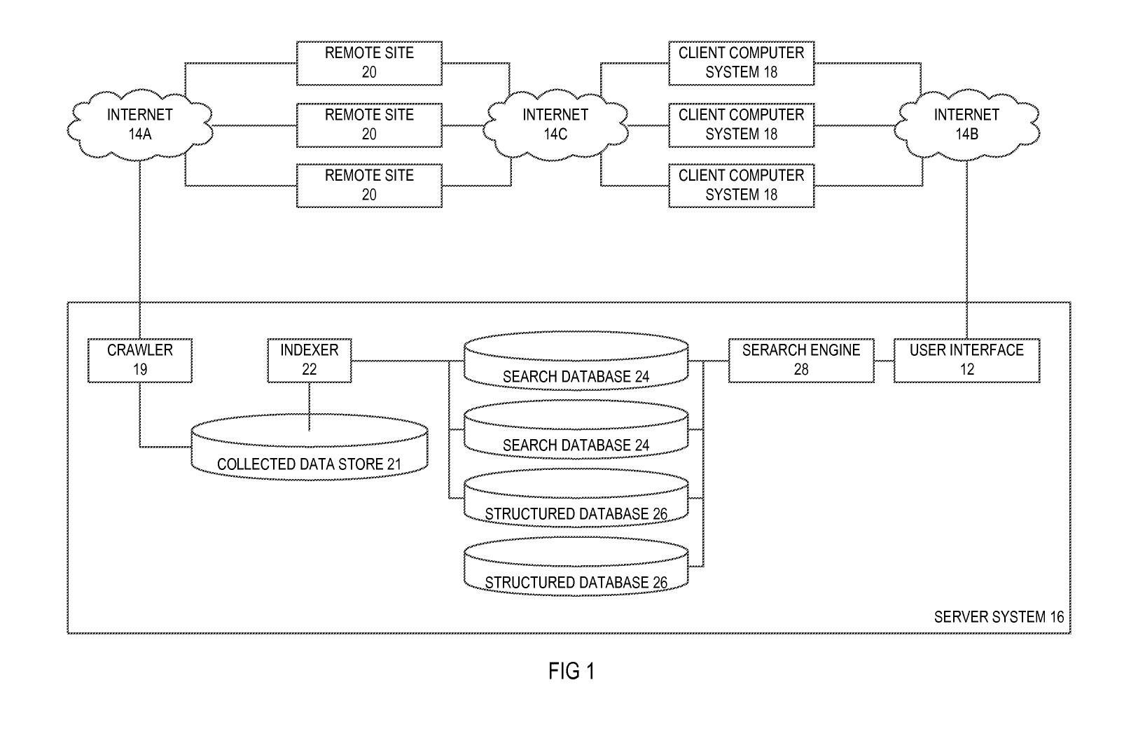

FIG. 1 of the accompanying drawings illustrates a network environment 10 that includes a user interface 12, the internet 14A, 14B and 14C, a server computer system 16, a plurality of client computer systems 18, and a plurality of remote sites 20, according to an embodiment of the invention.

The server computer system 16 has stored thereon a crawler 19, a collected data store 21, an indexer 22, a plurality of search databases 24, a plurality of structured databases and data sources 26, a search engine 28, and the user interface 12. The novelty of the present invention revolves around the user interface 12, the search engine 28 and one or more of the structured databases and data sources 26.

The crawler 19 is connected over the internet 14A to the remote sites 20. The collected data store 21 is connected to the crawler 19, and the indexer 22 is connected to the collected data store 21. The search databases 24 are connected to the indexer 22. The search engine 28 is connected to the search databases 24 and the structured databases and data sources 26. The client computer systems 18 are located at respective client sites and are connected over the internet 14B and the user interface 12 to the search engine 28.

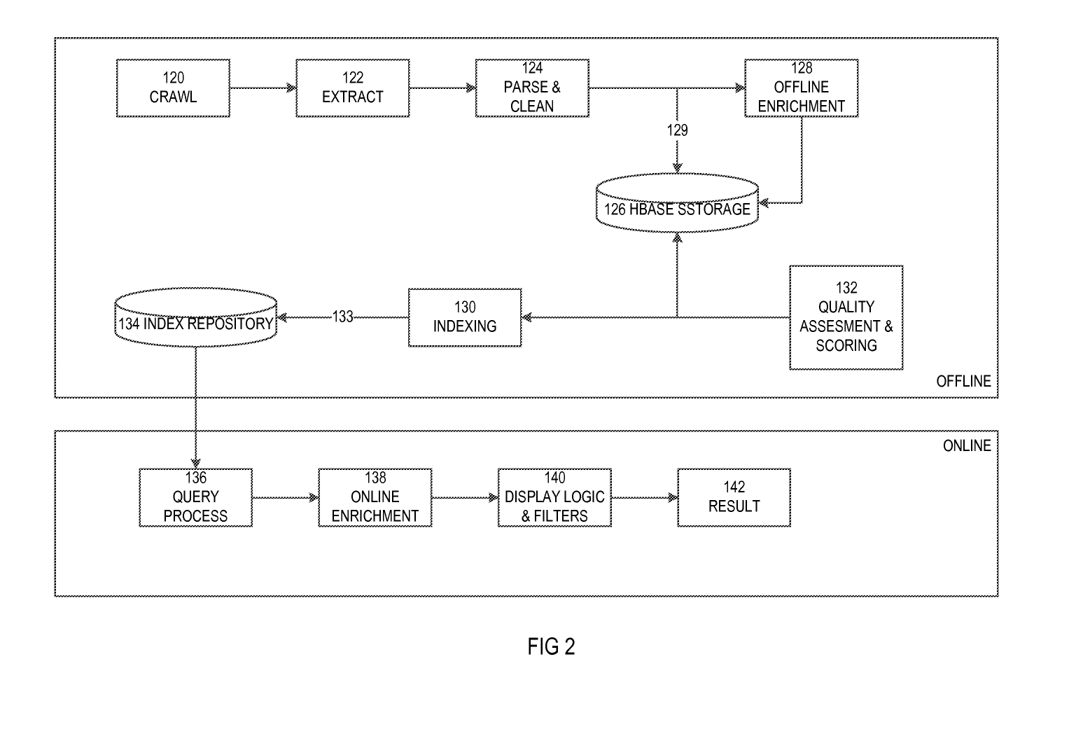

FIG. 2 shows an overall process flow for concept extraction and its use in more detail than what is shown in FIG. 1. At 120, the system crawls the Internet for documents that can be used as results. At 122, the system extracts results from the documents provided by the crawler 120 for purposes of building a search database. At 124, the system parses and cleans the documents. At 129, the system stores the documents in hierarchical database (HBASE) storage 126. At 128, the system executes offline enrichment for purposes of determining concepts within the documents stored in the HBASE storage 126.

At 130, the system indexes the documents. At 132, the system performs a quality assessment and scoring of the results within the HBASE storage 126. At 133, the system stores the indexed results within an index repository 134, which completes offline processing.

At 136, the system processes a query with a query processor. At 138, the system executes online enrichment of the documents in response to the receiving and the processing of the query at 136. At 140, the system displays logic and filters for a user to customize the results. At 142, the system displays the results to the user. Steps 136 through 142 are all executed in an online phase in response to receiving a query.

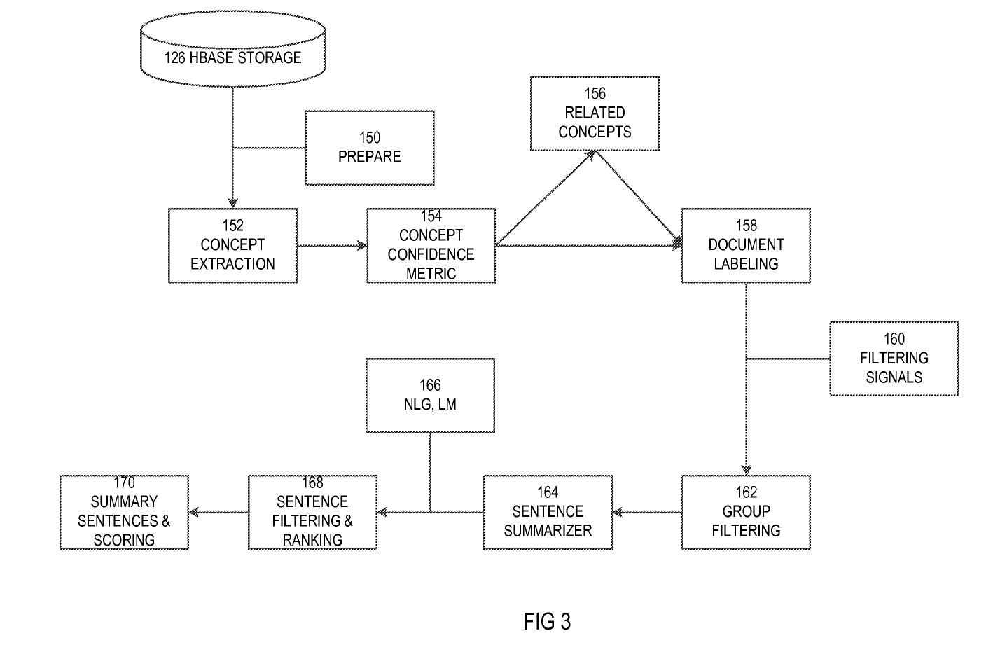

FIG. 3 illustrates the offline enrichment step 128 in more detail as it relates to the HBASE storage 126. At 150, the data within the HBASE storage 126 is prepared for concept extraction. At 152, concepts are extracted from the documents within the HBASE storage 126. At 154, a concept confidence metric is applied to the concepts that are extracted at 152. At 156, related concepts are determined, typically from a related concept data store. At 158, a document labeling step is carried out wherein the results within the HBASE storage 126 are labeled. At 160, filtering signals are applied. At 162, group filtering is executed based on the filtering signals applied at 160. At 164, a sentence summarizer step is executed. At 166 natural language generation (NLG) and language modeling (LM) are carried out. At 168, sentence filtering and ranking is executed. At 170, summary sentences and scores are provided and stored based on the sentence filtering and ranking executed at 168.

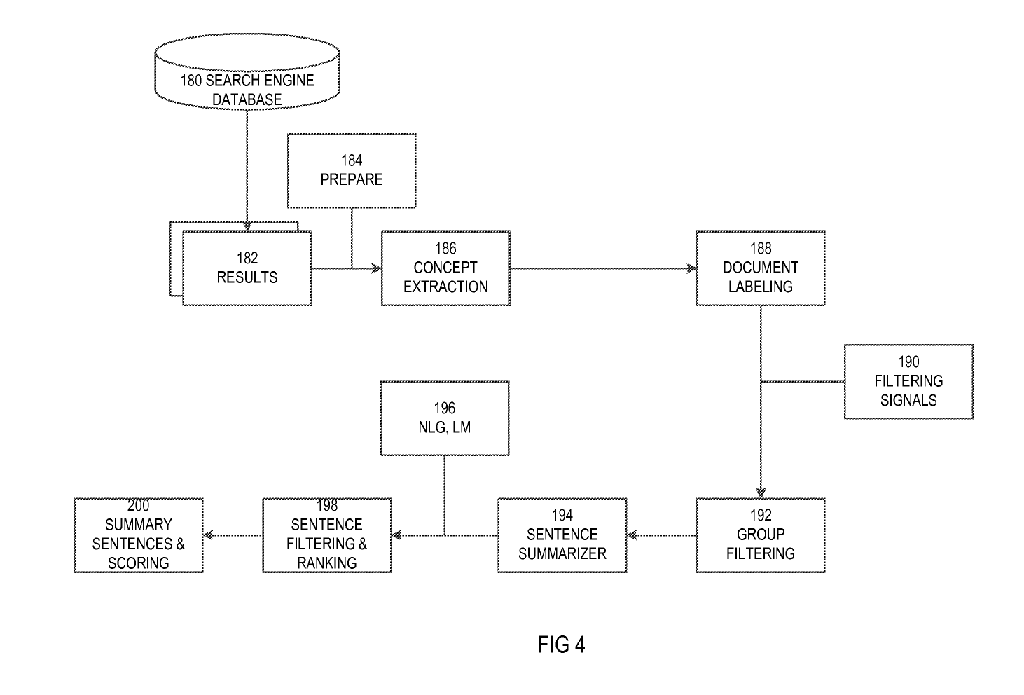

FIG. 4 shows the online enrichment 138 in more detail. A search engine database 180 is used to narrow the number of documents stored at 134 in the index repository to a total of 200. The search engine database 180 is an auxiliary search engine database that is different than the search database 24 shown in FIG. 1. A search engine is used to determine the most relevant results that match documents in the search engine database 180. The output of the search engine is then stored at 182 as the results. At 184, the results stored at 182 are prepared for concept extractions. At 186, a concept extraction step is carried out. At 188, a document labeling step is carried out wherein the results within the HBASE storage 126 are labeled. At 190, filtering signals are applied. At 192, group filtering is executed based on the filtering signals applied at 190. At 194, a sentence summarizer step is executed. At 196 natural language generation (NLG) and language modeling (LM) are carried out. At 198, sentence filtering and ranking is executed. At 200, summary sentences and scores are provided and stored based on the sentence filtering and ranking executed at 198.

Offline enrichment as shown in FIG. 3 may take multiple hours to complete. Online enrichment as shown in FIG. 4 is typically accomplished in 50 ms or less because of multiple reasons that include limiting the number of results 182 to 200. Offline enrichment however renders a more comprehensive set of documents than online enrichment.

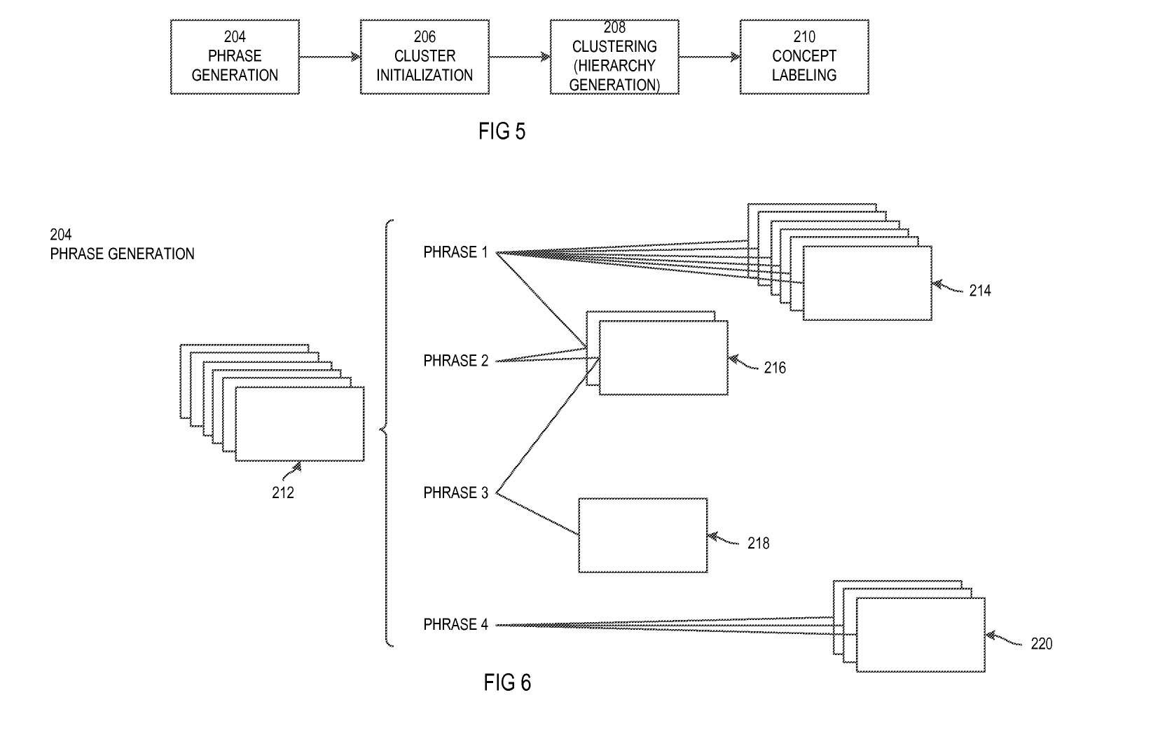

FIG. 5 illustrates the concept extraction phase 152 or 186 in more detail. At 204, a phrase generation operation is carried out wherein phrases are generated from the results stored in the HBASE storage 126. At 206, a cluster initialization phase is carried out wherein clustering of the phrases is initiated. At 208, a clustering phase is carried out. The key phrases extracted at 204 are used for cluster similarity. The results of each cluster slot are clustered by creating trees with respective nodes representing the results that are similar. At 210, a labeling operation is carried out. A concept of each tree is determined and the tree is labeled with the concept. The key phrases extracted at 204 are used for labeling. The operations carried out at 204, 206, 208 and 210 result in the generation of a hierarchical data structure based on concepts within the documents in the HBASE storage 126.

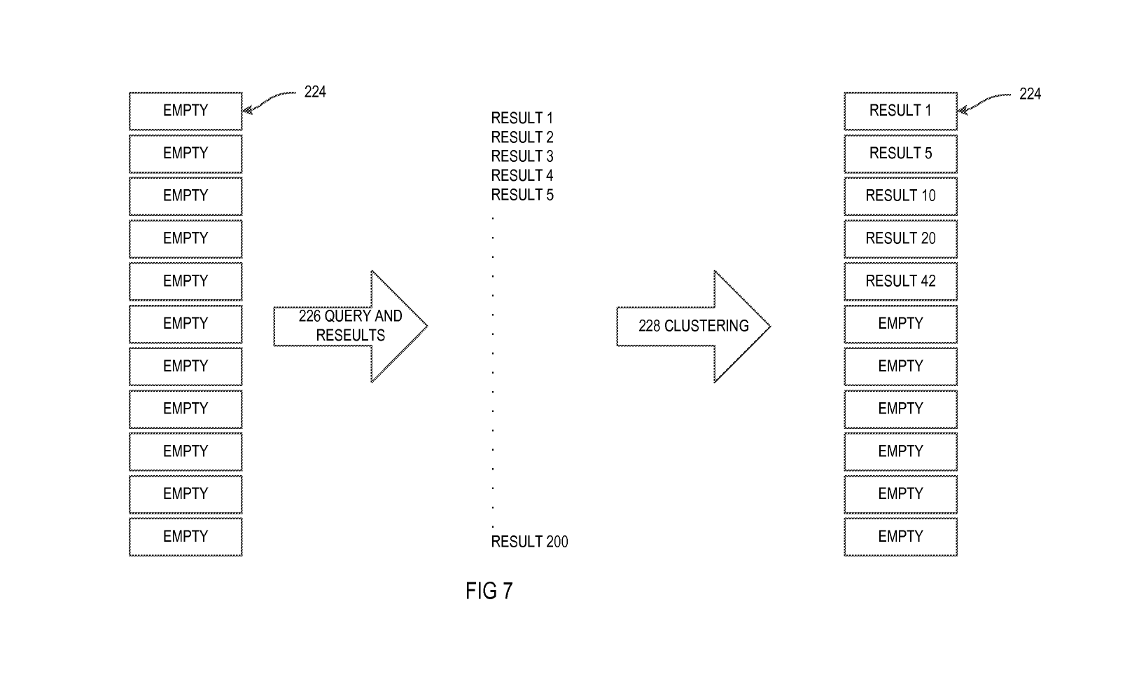

FIG. 6 illustrates the phrase generation phase 204 in more detail. The documents stored within the HBASE storage 126 are represented as documents 212. Phrases are then identified within the documents 212, i.e. phrase 1, phrase 2, phrase 3, phrase 4, etc. The phrases are uni-grams, bi-grams, tri-grams, tetra-grams, penta-grams, hexa-grams and hepta-grams in the offline phase. For the online phase, the phrases include only uni-grams, bi-grams, tri-grams, tetra-grams and penta-grams. The documents 214 correspond to all the documents within the documents 212 having the first phrase, i.e. phrase 1. The documents 216 include all the documents 212 that include the second phrase, i.e. phrase 2. The documents 218 include all the documents from the documents 212 that include the third phrase, i.e. phrase 3. The documents 220 include all the documents s from the documents 212 that include the fourth phrase, i.e. phrase 4. All the phrases are extracted from text in the documents 212. Although the documents are shown in groups, no clustering has yet been executed.

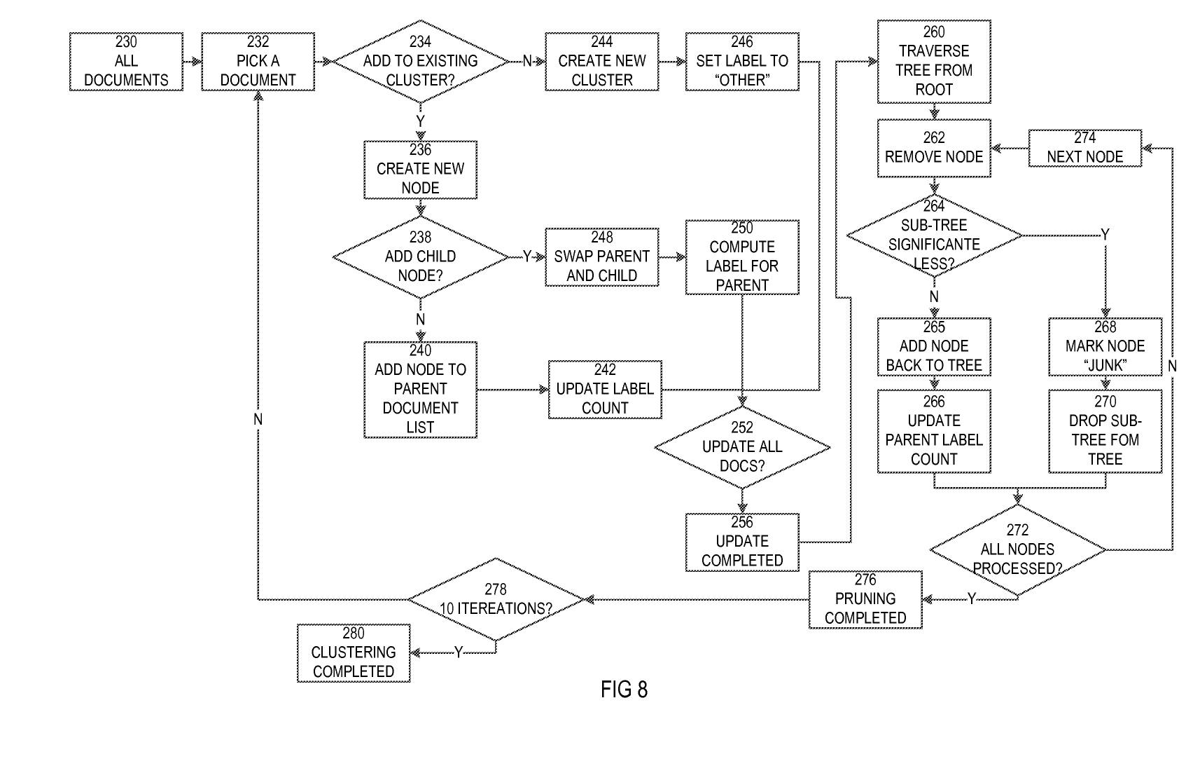

FIG. 7 shows the clustering initialization phrase 206 in more detail. Ten slots 224 are initially provided that are all empty. Query-based results are then determined at 226 from the documents. The results from the query are represented as result 1, result 2, result 3, etc. For the online phase, the number of results is limited to 200, whereas for the offline phase the number of results is not limited. At 228, the results are clustered and are entered into the slots 224. Respective results are entered into each of a plurality of cluster slots 224. Only one result is entered for multiple results that are similar. The first result, namely result 1, is entered into the first slot 224. If another result is similar to result 1, then that result is not entered into any slots 224. Similarity is determined based on similarity between key phrases in different results. As such, each slot 224 represents a result that is different from all other results in the slots 224. In the present example, only five results are entered, namely result 1, result 5, result 10, result 20 and result 42. The other five slots 224 are thus left open. If and when all the slots 224 are full, i.e. when a respective result is entered into each one of the ten slots 224, then the number of slots 224 is expanded, for example to eleven. If the eleventh slot is then also filled, then the number of slots 224 is expanded to twelve. At this stage, not only is each slot 224 filled with a unique result, but a determination is also made which other results are similar to a respective one of the results entered into the slots 224.

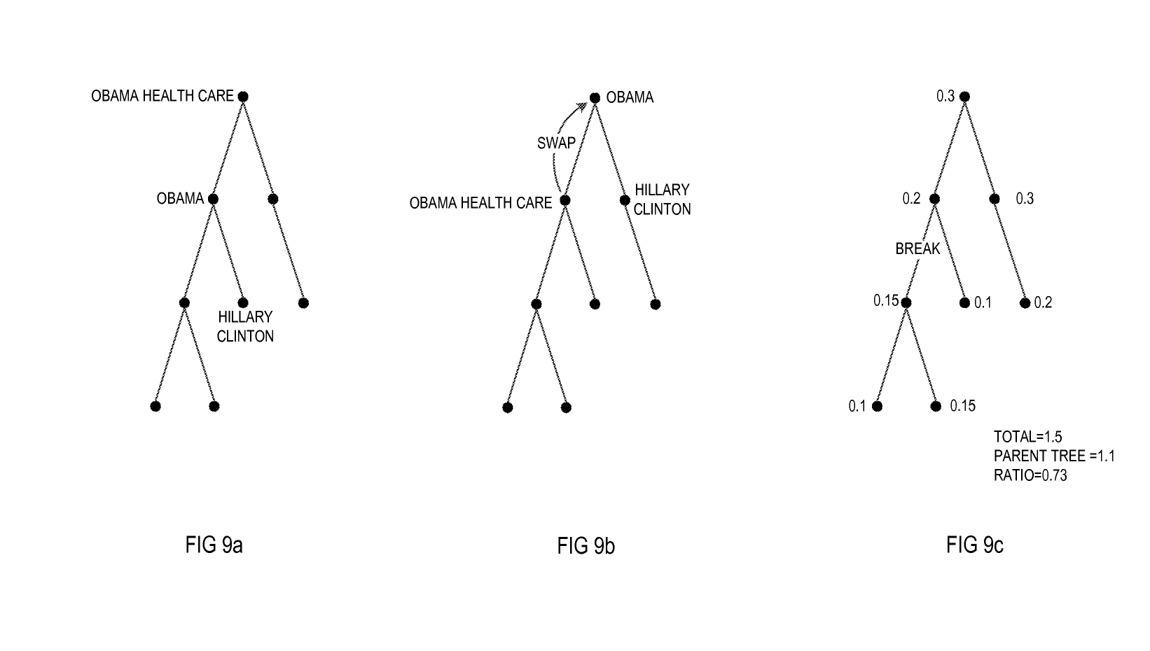

FIG. 8 illustrates the clustering phase 208 in more detail. At 230, all documents are stored. Steps 232 to 252 represents clustering by creating a plurality of trees, each tree representing a respective cluster. At 232, one of the documents is picked. At 234, a determination is made whether to add the document to an existing cluster. If a determination is made to add the document to an existing cluster, then at 236 a new node is created representing the newly added document. At 238, a determination is made whether to add the document as a child node of a parent node. If the determination is made to add the node as a child node, then at 240 the new node is added to the parent document list. At 242, the label count of the cluster is updated. If the determination is made at 238 not to add the new document as a child node, then at 248, the parent and child nodes are swapped. At 250, a label for the parent is computed.

If a determination at 234 is made not to add the document to an existing cluster, then at 244 a new cluster is created. At 246, a label of the new cluster is set to “other”.

Following 242, 246 or 250, a determination is made at 252 whether all documents are updated. If all documents are not updated, then the procedure is repeated at step 232. If all documents are updated, then at 256 a determination is made that the update of the document is completed.

Steps 260 to 276 are carried out after step 256 and are used for determining or computing a significance of a tree resulting from the tree creation steps in steps 234 to 252.

At 260, a tree is traversed from its root. At step 262, a node is removed from the tree. At step 264, a determination is made whether a sub-tree that results from the removal of the node has a score that is significantly less than a score of the tree before the node is removed. If the determination at 264 is that the score is not significantly less then, at 264, the node is added back to the tree at 265. At 266, the parent label count is updated with the node added back in. If the determination at 264 is that the score of the sub-tree is significantly less than the tree before the node is removed, then, at 268, the node is marked as “junk” and at 270 the tree or sub-tree is dropped.

After the steps 266 or 270 a determination is made at 272 whether all nodes of the tree have been processed. If all nodes of the trees have not been processed, then at 274, a next node is processed by removing the node at 262. If the determination at 272 is that all nodes have been processed, then a determination is made at 276 that pruning is completed.

At step 278, a determination is made as to whether a predetermined number of iterations have been completed. The determination at 278 is only made for the online version because of speed of processing is required. In the online version 10 iterations may for example be completed, whereafter the system proceeds to step 280 wherein a determination is made that clustering has been completed. In the offline version, the process described in steps 230 to 276 is repeated until no more pruning occurs, i.e. no more swapping happens in step 248 or no more sub-trees are dropped in step 270.

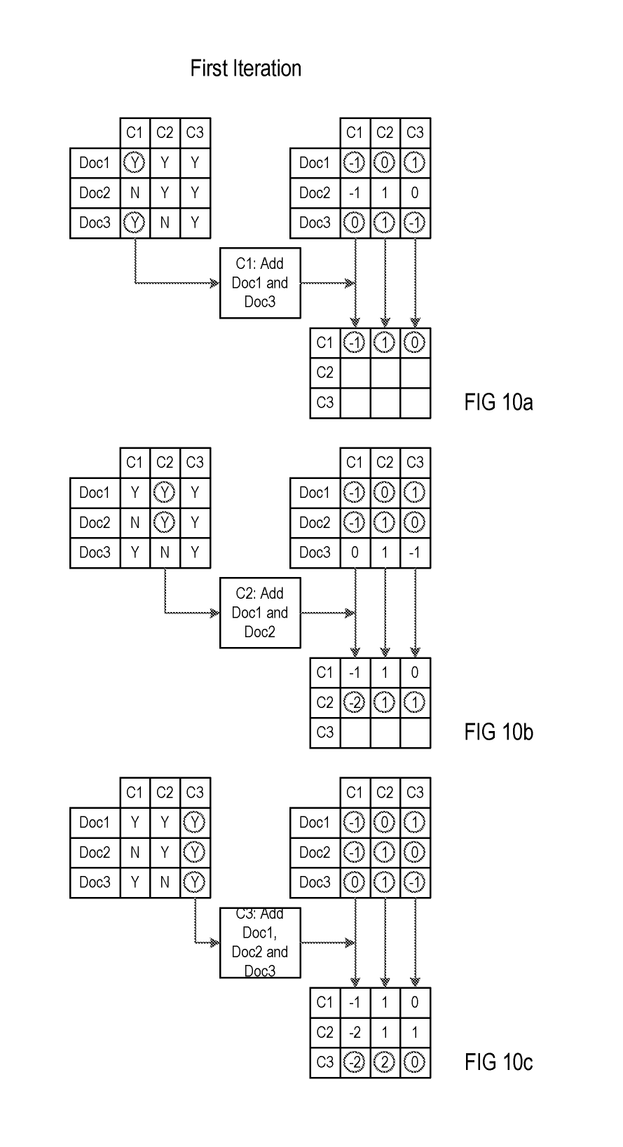

FIG. 9a shows a tree that is constructed after a number of iterations through step 236 in FIG. 8. Each node of the tree represents a different document. FIG. 9b shows a swapping operation that occurs at step 248 in FIG. 8. FIG. 9c shows a tree with a node that is removed at step 262 in FIG. 8. A sub-tree that includes the bottom three nodes marked 0.15, 0.1, 0.15 is removed leaving a parent tree behind. The significance score of the parent tree is 1.1, whereas the combined tree that includes the parent tree and the sub-tree is 1.5. A ration of 0.73 is calculated representing a significance of the parent tree relative to the combined tree. A threshold of 0.8 may for example be set for the ration, indicating that the parent tree has lost too much from the combined tree, in which case the sub-tree is added back at step 265 in FIG. 8.

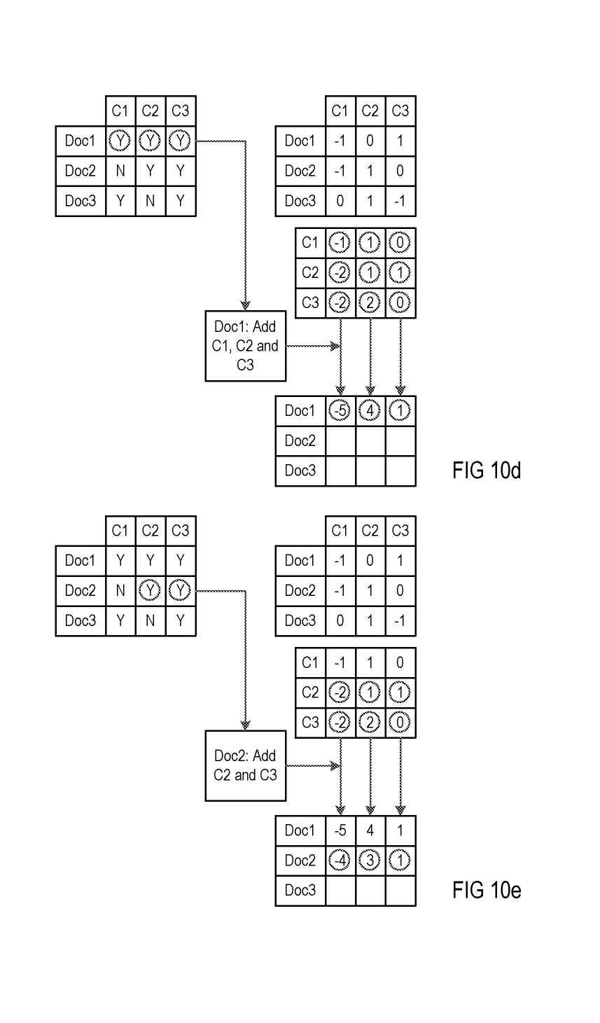

As shown in FIG. 10a, a reference set of documents is stored as represented by the matrix in the top left. Each document (Doc1, Doc1, Doc3) has one or more concepts (C1, C2, C3) associated therewith as represented by the yes (Y) or no (N) in the cell where row of a respective document intersects with a cell of a respective concept.

An input set is generated as represented by the matrix in the top right. The input set includes the documents and concepts from the reference set and a random document vector represented at an intersection of each document and each concept. The random vectors may for example be generated using the commonly known RND function.

A plurality of iterations are then carried out in order to finding a concept vector set and a document vector set.

FIGS. 10a to 10f show a first iteration that is carried out.

Prior to FIG. 10a all concept vectors for all concepts in the input set are emptied from a concept vector set shown in the bottom right of FIG. 10a.

As further shown in FIG. 10a, for a first concept (C1) in the reference set, the following procedure is carried out:
1. a document set (circled Y's) is determined that includes all the documents in the reference set (top left) in which the concept (C1) appears;
2. a concept vector input is obtained by adding the document vectors (circles in matrix top right) in the input set corresponding to the documents in the document set; and
3. the concept vector input (circles in matrix top right) is then added to the concept vector for the concept to the concept vector set (matrix bottom right).

As shown in FIG. 10b, for a second concept (C2) in the reference set, the following procedure is carried out:
1. a document set (circled Y's) is determined that includes all the documents in the reference set (top left) in which the concept (C2) appears;
2. a concept vector input is obtained by adding the document vectors (circles in matrix top right) in the input set corresponding to the documents in the document set; and
3. the concept vector input (circles in matrix top right) is then added to the concept vector for the concept to the concept vector set (matrix bottom right).

As shown in FIG. 10c, for a third concept (C3) in the reference set, the following procedure is carried out:
1. a document set (circled Y's) is determined that includes all the documents in the reference set (top left) in which the concept (C3) appears;
2. a concept vector input is obtained by adding the document vectors (circles in matrix top right) in the input set corresponding to the documents in the document set; and
3. the concept vector input (circles in matrix top right) is then added to the concept vector for the concept to the concept vector set (matrix bottom right).

Prior to FIG. 10d all document vectors for all documents in the input set are emptied from a document vector set shown in the bottom right of FIG. 10d.

As shown in FIG. 10d, for a first document (Doc1) in the reference set, the following procedure is carried out:
1. a concept set (circled Y's) is determined that includes all the concepts in the reference set (top left) in which the document (Doc1) appears;
2. a document vector input is obtained by adding the concept vectors (circles in matrix middle right) in the input set corresponding to the concepts in the concept set; and
3. the document vector input (circles in matrix middle right) is then added to the document vector for the document to the document vector set (matrix bottom right).

As shown in FIG. 10e, for a second document (Doc2) in the reference set, the following procedure is carried out:
1. a concept set (circled Y's) is determined that includes all the concepts in the reference set (top left) in which the document (Doc2) appears;
2. a document vector input is obtained by adding the concept vectors (circles in matrix middle right) in the input set corresponding to the concepts in the concept set; and
3. the document vector input (circles in matrix middle right) is then added to the document vector for the document to the document vector set (matrix bottom right).

As shown in FIG. 10f, for a third document (Doc3) in the reference set, the following procedure is carried out:
1. a concept set (circled Y's) is determined that includes all the concepts in the reference set (top left) in which the document (Doc3) appears;
2. a document vector input is obtained by adding the concept vectors (circles in matrix middle right) in the input set corresponding to the concepts in the concept set; and
3. the document vector input (circles in matrix middle right) is then added to the document vector for the document to the document vector set (matrix bottom right).

After FIG. 10f all concept vectors for all concepts in the input set are emptied from a concept vector set shown in the bottom right of FIG. 10a. Furthermore, all document vectors for all documents in the input set are emptied from a document vector set shown in the bottom right of FIG. 10d.

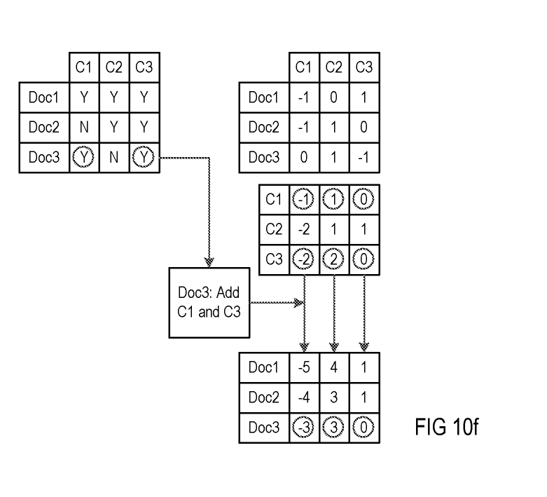

The document vector set (matrix bottom right) in FIG. 10f then forms the document set (matrix top right) in FIG. 11a. FIGS. 11a to 11f show a second iteration that is carried out. The iterations can be continued until the concept vector set and document vector set do not change anymore or when the changes from one iteration to the next are less than a predetermined maximum.

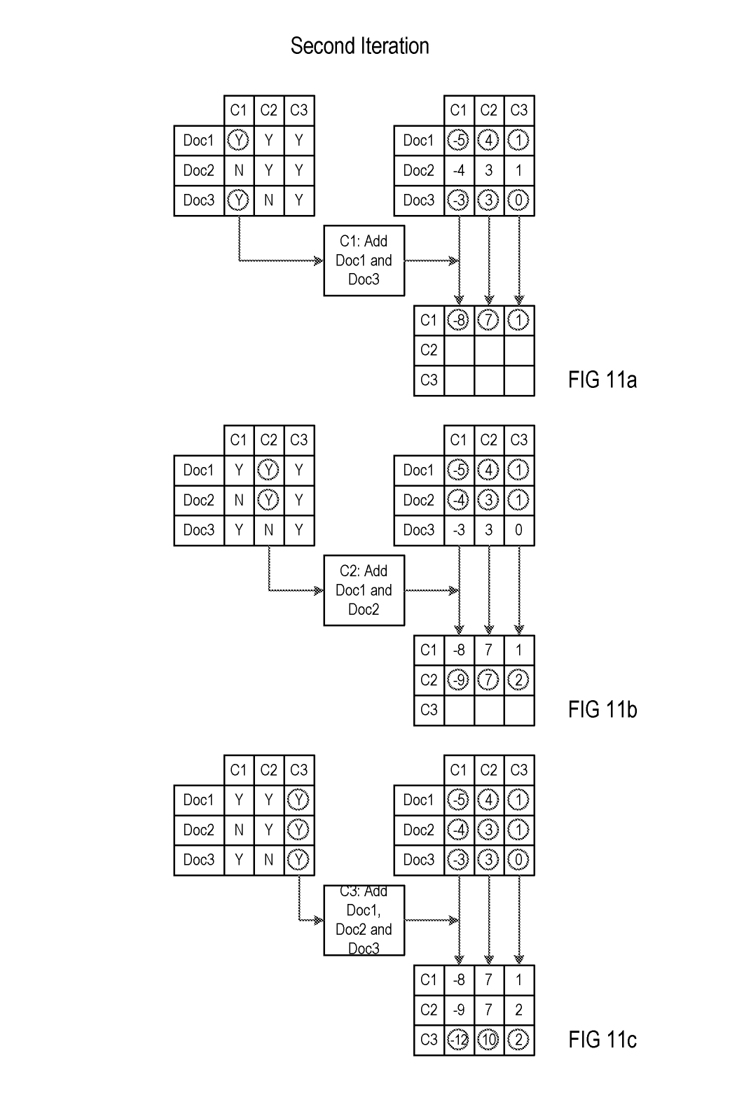

FIG. 12 shows the concept vector set in the matrix on the left. For each concept pair (C1 and C2) in the concept vector set, the following procedure is carried out:
1. a relatedness between the concepts of the pair is determined by calculating a similarity score (e.g., C1 and C2 have a similarity score of 0.99) of the concept vectors of the concepts of the pair;
2. a subset of the relatedness scores is retained for the concepts having a predetermined threshold; and
3. the relatedness score for the concepts of the pair is written into in a related concepts store (matrix on the right).

Relatedness between concepts can be calculated using a cosine similarity calculation, for example:

C1:C2:(8*9+7*7+1*2)/(sqrt(8*8+7*7+1*1)*sqrt(9*9+7*7+2*2))=123/(10.67*11.57)=0.99

C1:C3=(8*12+7*10+1*2)/(sqrt(8*8+7*7+1*1)*sqrt(12*12+10*10+2*2)==168/10.67*15.74=0.98

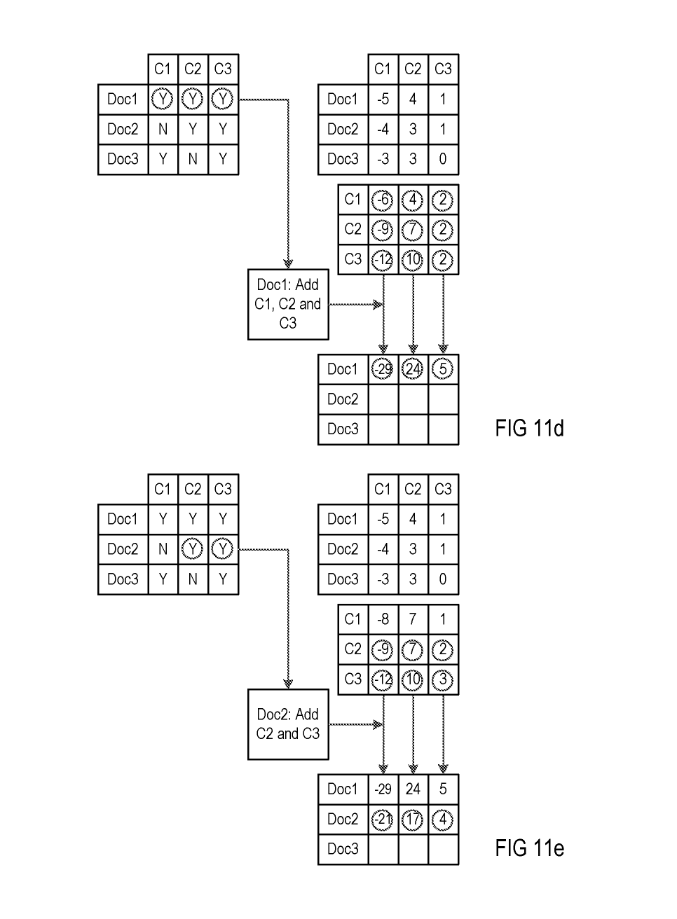

FIG. 13 shows the document vector set in the matrix on the left. For each document pair (Doc1 and Doc2) in the document vector set, the following procedure is carried out:
1. a relatedness between the documents of the pair is determined by calculating a similarity score (e.g., Doc1 and Doc2 have a similarity score of 0.81) of the document vectors of the documents of the pair;
2. a subset of the relatedness scores is retained for the documents having a predetermined threshold; and
3. the relatedness score for the documents of the pair is written into in a related documents store (matrix on the right).

Relatedness between documents can be calculated using a cosine similarity calculation, for example:

Doc1−Doc3:(29*20+24*17+5*4)/(sqrt(29*29+24*24+5*5)*sqrt(20*20+17*17+4*4)=1208/37.97*26.55=0.80

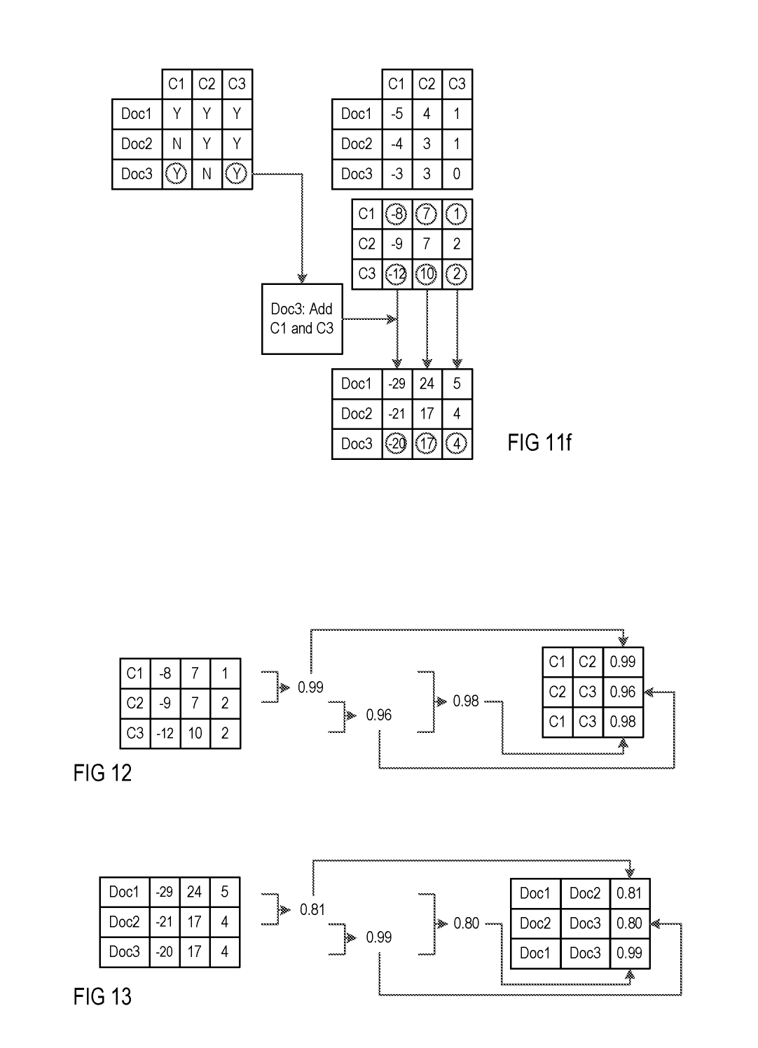

FIG. 14 illustrates a related storage component 500 that received. The related storage component 500 includes a plurality of concepts for storage and their relatedness to one another. The concepts are represented at nodes. Relatedness is represented by lines connecting nodes. Each line also has a relatedness score as calculated using the method hereinbefore described.

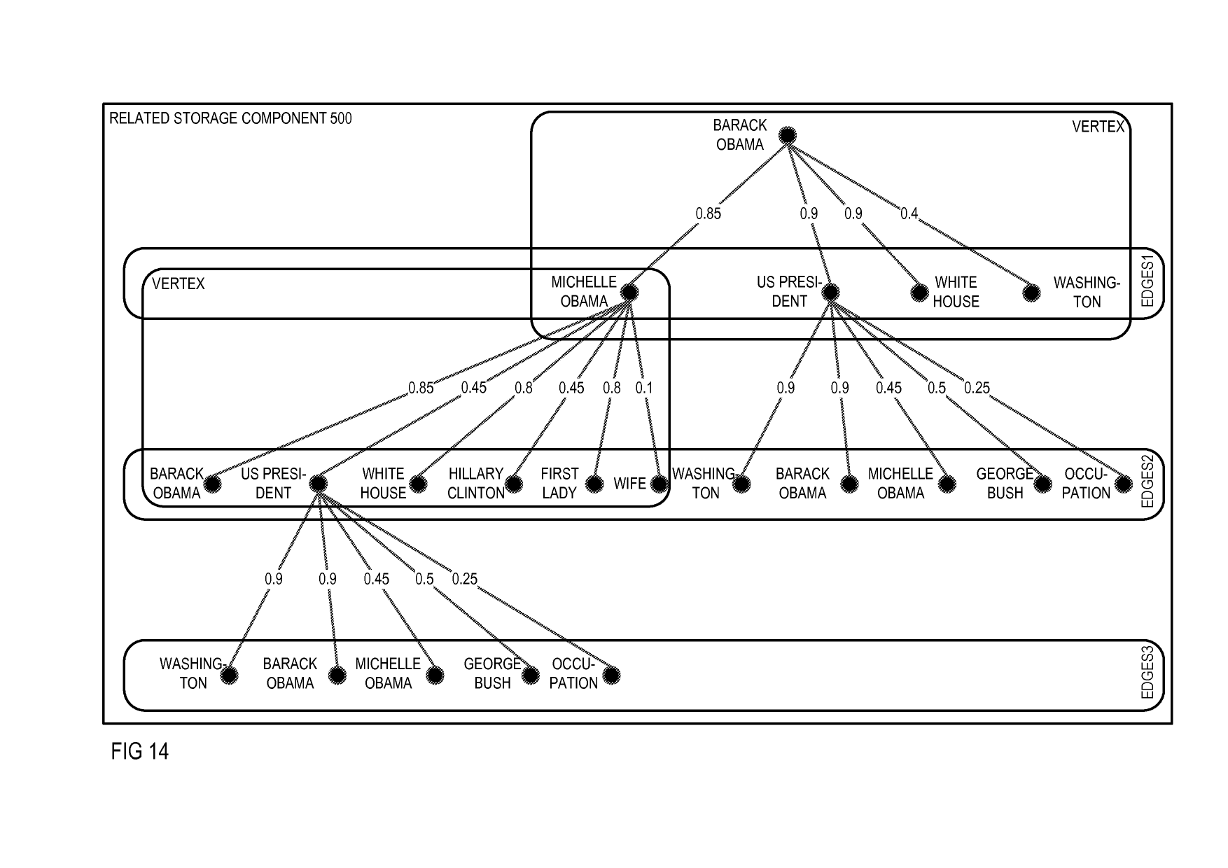

FIG. 15 illustrates storing of one of a plurality of vertex indexes based on the concepts for storage in FIG. 14. The vertex index has a plurality of vertexes that are stored in separate lines of code. Each vertex reflects a relationship between a concept acting as a primary node and a plurality of the concepts acting as secondary nodes in FIG. 14.

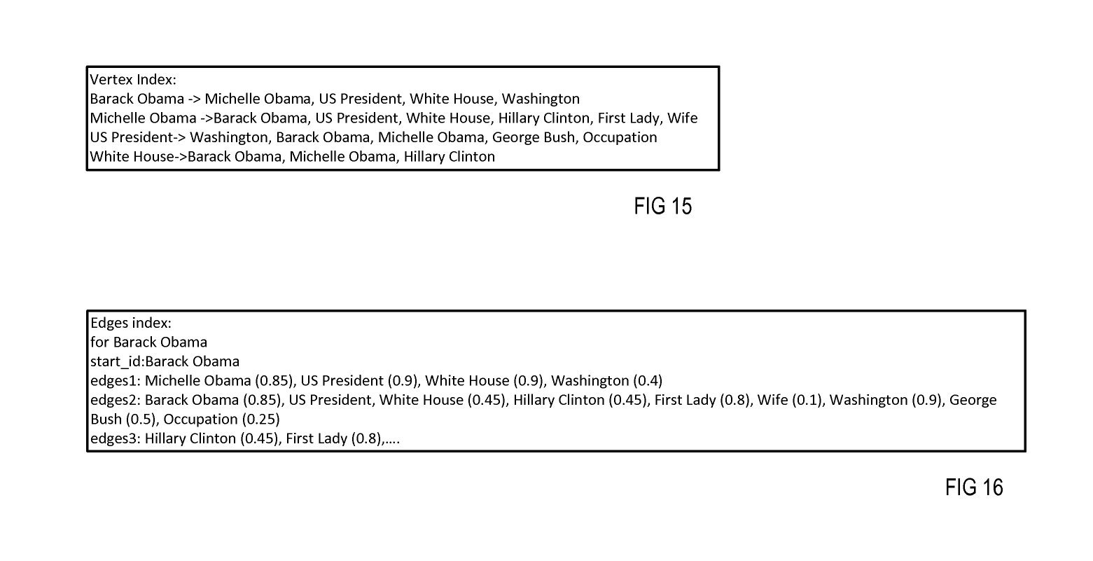

FIG. 16 illustrates storing of one of a plurality of edges indexes based on the concepts for storage in FIG. 14. The edges index has a plurality of edges represented in separate lines of code. A first of the edges (edges1) reflects a relatedness between a first of the concepts (Barack Obama) and a plurality of second ones of the concepts together with their relatedness scores (Michelle Obama (0.85), US President (0.9), White House (0.9), Washington (0.4)). A second of the edges (edges2) reflects a relatedness between each one of the second concepts and a plurality of third concepts related (Barack Obama (0.85), US President, White House (0.45), Hillary Clinton (0.45), First Lady (0.8), Wife (0.1), Washington (0.9), George Bush (0.5), Occupation (0.25)) to each one of the second concepts. A third of the edges (edges3) reflects a relatedness between each one of the third concepts and a plurality of fourth concepts (Hillary Clinton (0.45), First Lady (0.8), . . . ) related to each one of the third concepts.

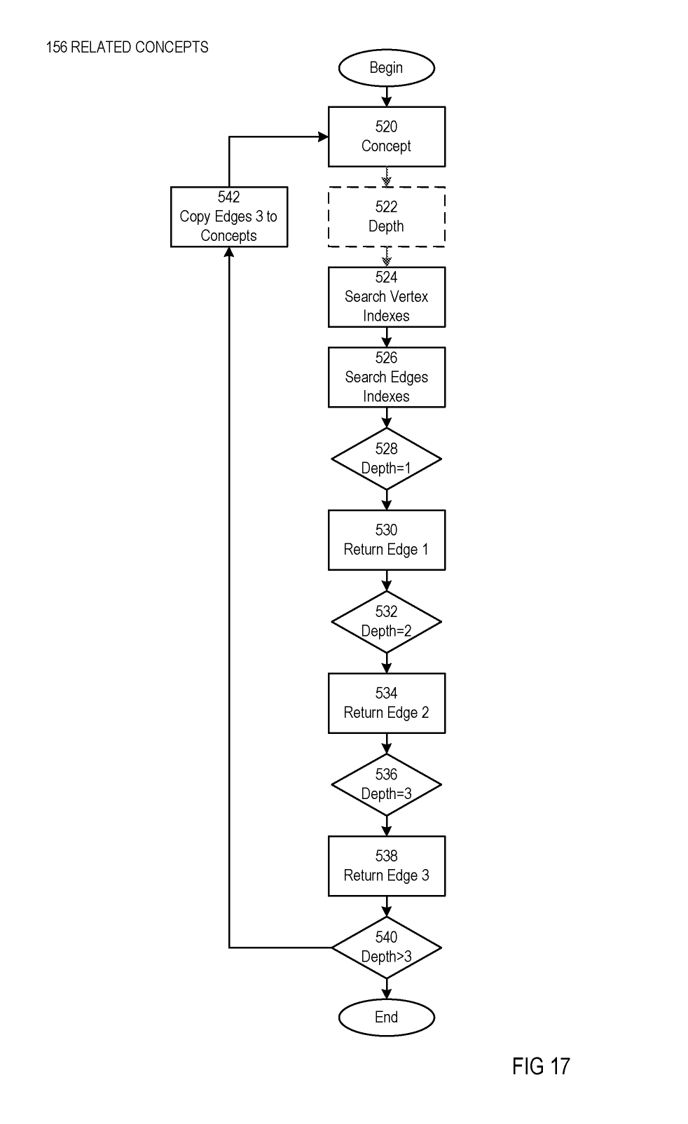

FIG. 17 illustrates how the vertex indexes (one of which is shown in FIG. 15) and the edges indexes (one of which is shown in FIG. 16) are searched.

At 520 a concept for searching is received (e.g, Barack Obama).

At 522 a depth is received.

As described with respect to FIG. 15, a plurality of vertex indexes are stored based on the concepts for storage, wherein each vertex index has a plurality of vertexes, wherein each vertex reflects a relationship between a concept acting as a primary node and a plurality of the concepts acting as secondary nodes. At 524 a plurality of documents are determined based on the plurality of concepts acting as primary and secondary nodes.

At 526 searching is carried out among the edges indexes for a selected edges index having the concept for searching as the first concept (e.g., the edges index in FIG. 16).

At 530, 534 and 538 a number of the concepts of the selected edges indexes are returned. The number of edges for which concepts are returned are equal to the depth if the depth is one, two or three. If at 528 a determination is made that the depth is one then only the edges in the first line are returned at 530. If at 532 a determination is made that the depth is two then the edges in the second line are returned at 534 in addition to the edges returned at 530. If at 536 a determination is made that the depth is three then the edges in the third line are returned at 538 in addition to the edges returned at 530 and 534.

If at 540 a determination is made that the depth is more than three then at 542 the concepts of the third edges are copied as replacement concepts for searching, and are received at 520. The process is then repeated for the replacement concepts, except that the depth does not have to be received again. In particular, at 530 to 538 searching is carried out among the edges indexes for selected repeat edges indexes having the replacement concepts for searching as the first concept and a number of the concepts of the selected repeat edges indexes are returned. The number of repeat edges for which concepts are returned are equal to the depth minus three.

The concepts returned based on the edges indexes are then used to determine relevance of the documents selected at 524.

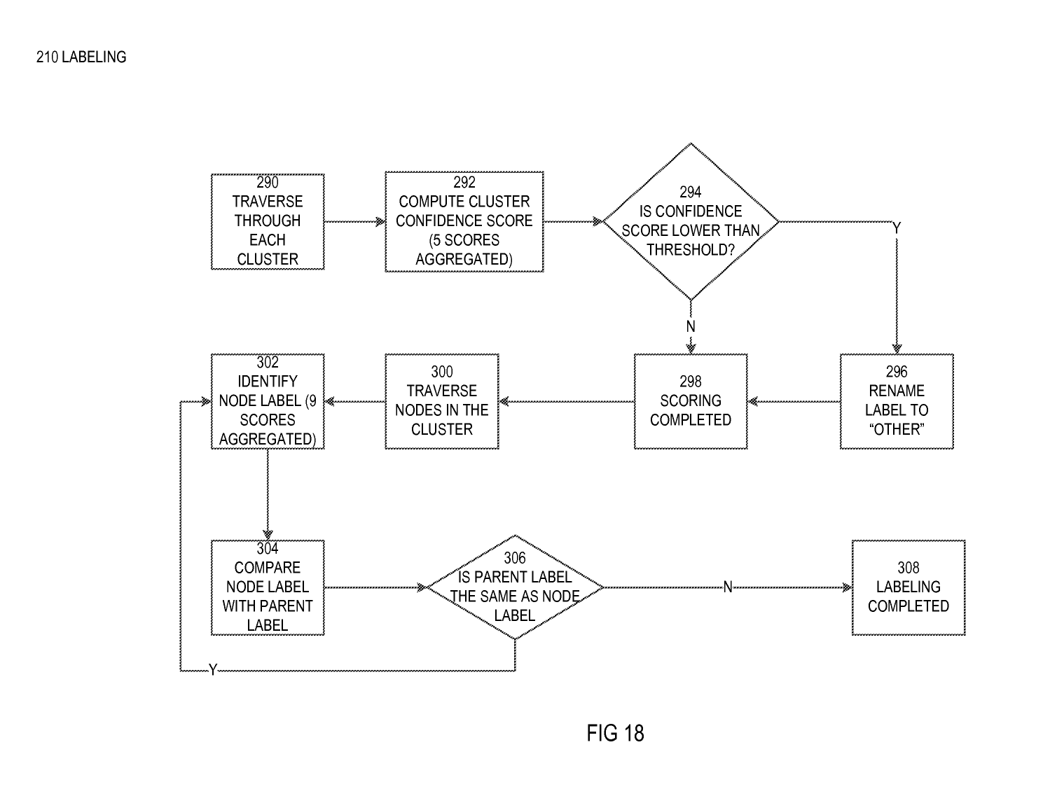

FIG. 18 illustrates the labeling 210 in more detail. At 290, the system traverses through each cluster after the clustering is done at 280. At 292, the system computes a cluster confidence score. The cluster confidence score is computed based on the following four factors:
1. The number of different sources that are included within the cluster;
2. The length of the maximum sentence;
3. The number of different domains; and
4. The order of ranking within the search engine database 180; and
5. The number of occurrences.

At 294, a determination is made whether the confidence score is lower than a predetermined threshold value. If the determination at 294 is that the confidence score is lower than the threshold then a label for the cluster is renamed at 296 to “other.” If the determination at 294 is that the confidence score is not lower than the predetermined threshold then a determination is made at 298 that the scoring is completed.

At 300, the system traverses the nodes in the cluster. At 302, the system identifies a node label for each one of the nodes. The node label of the respective node is determined based on the following nine factors that are aggregated:
1. Number of times the label appears (Frequency score);
2. Length of n-gram (Length-score: the higher the length better it is for example ngram=“Barack Obama” is much better then n-gram=“Barack” or n-gram=“Obama”).
3. Number of other n-grams/label co-occurring with the current label. (Spread Score: labels most co-occurring are grouped together).
4. Number of different results the concept occurs in. (IDF score: if c1.count==3 and c1.results==3 this is much higher quality, then c1.count=3 and c1.results=1).
5. Rank-order of the results in which label occurs in. (Peak-Score: labels from result1 gets greater score then labels from result2 and so on . . . ).
6. Stop-Word/Punctuations score: Label which contains stop-word or punctuations gets a negative score.
7. Label term score: if the label consists of high score terms it gets additional score.
8. Unique term score: if the label does not consist of repeating words it gets additional score.
9. Collocation score: Collocation score which tells how good the label formation is.

At 304, the label of the node is compared with a parent label of a parent node. At 306, a determination is made whether the parent label is the same as the label for the node. If the determination at 306 is made that the label of the parent is the same, then another node label is identified for the node at 302. Steps 302, 304 and 306 are repeated until the label for the child node is different than the label for the parent node. If the determination at 306, is that the parent label is not the same as the label for the child node, then a determination is made at 308 that labeling is completed.

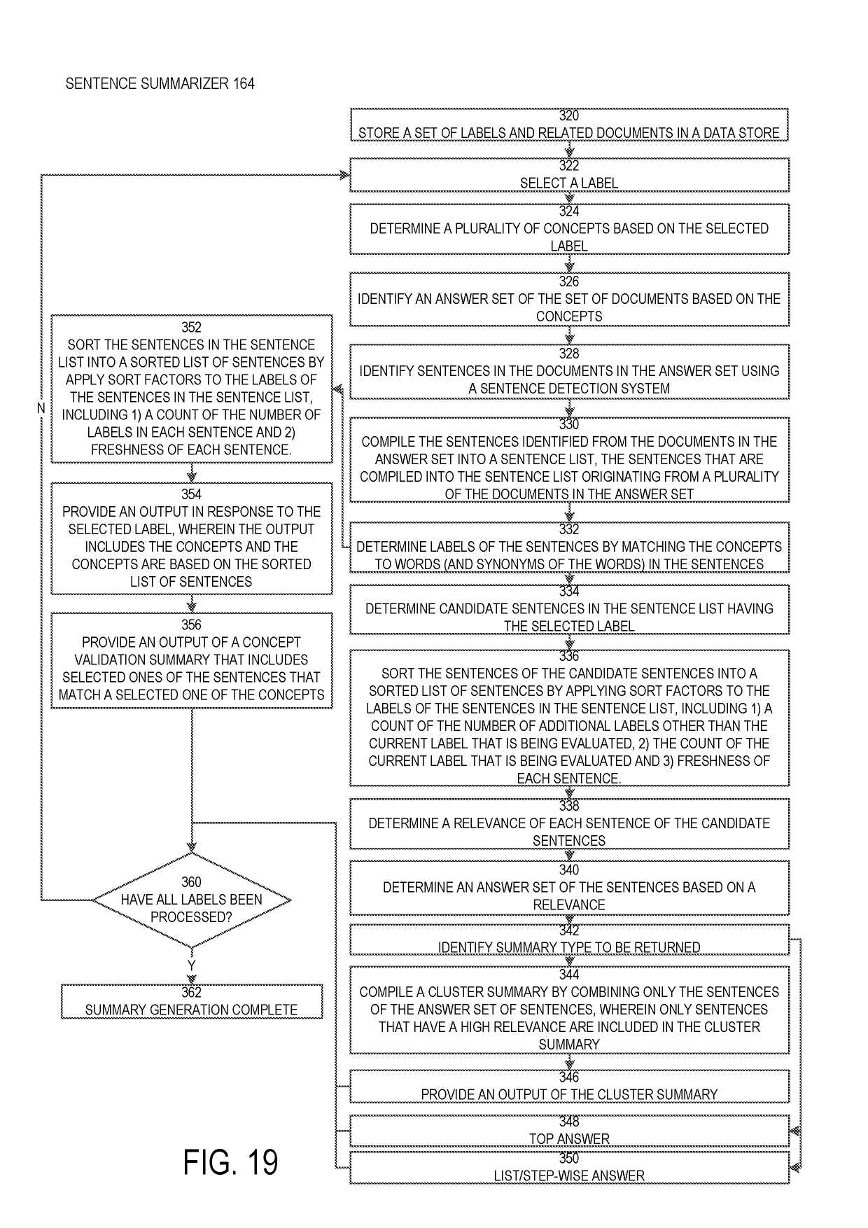

FIG. 19 shows a method that is used to find sentences and generate summaries for concepts within the documents. At 320, a set of labels and related documents are stored in a data store as hereinbefore described. At 322, one of the labels is selected. The label that is selected may for example be “poison ivy.”

At 324, a plurality of concepts is determined based on the selected label. The concepts may for example be “ivy plant,” “poison ivy rash,”, “three leaves,” “poison oak,” and “medical advice.” At 326, an answer set of the set of documents that are stored at 320 is determined based on the concepts. All the documents within the set of documents that have the listed concepts form part of the answer set to the exclusion of all other documents of the set of documents.

At 328, sentences are identified in the documents in the answer set using a sentence detection system. The sentence detection system may for example detect the end of a sentence at a period (“.”) or a question mark (“?”) or may make use of other training data to identify sentences. At 330, the sentences that are identified from the documents in the answer set are compiled into a sentence list. It should be noted that the sentences that are compiled into the sentence list originated from the plurality of documents in the answer set that is identified at 326.

At 332, labels of the sentences are identified by matching the concepts to words (and synonyms of the words) in the sentences. For example, the concept “poison ivy rash” can be identified in the sentence “A person who has got poison ivy rash may develop inflammation which is red color, blistering and bumps that don't have any color.” Some sentences do not have the original label selected at 322. For example, a sentence in the sentence list may be “Immediately seek medical advice if your skin turns red in color.” This sentence includes a concept, namely “medical advice” that is related to the label “poison ivy” selected at 322, but does not include the label selected at 322. The sentence list thus includes sentences that do not include the label selected at 322.

At 334, candidate sentences in the sentence list having the selected label are identified. In the given example all the candidate sentences have the label “poison ivy” therein.

At 336, the sentences of the candidate sentences are sorted into a sorted list of sentences by applying sort factors to the labels of the sentences in the sentence list. The sort factors include:
1. A count of the number of additional labels (e.g., “ivy plant,” “poison ivy rash,”, “three leaves,” “poison oak,” and “medical advice”) other than the current label (e.g. “poison ivy”) that is being evaluated;
2. The count of the current label (e.g., “poison ivy”) that is being evaluated; and
3. The freshness of each sentence which can be determined by a date that the sentence has been stored or a date of the document from which the sentence has originated.

At 338, a relevance of each sentence of the candidate sentences is evaluated. At 340, an answer set of the sentences is determined based on a relevance of each sentence.

At 342, a summary type that is to be returned is identified. Different processes are initiated at 344, 346 and 348 depending on the summary type that is identified at 342. If the summary type is a cluster summary type, then step 344 is executed followed by step 350. Another summary type may for example be a top answer summary type, in which case step 346 is executed. A top answer is one of the documents in the data store, in which case sentences from multiple documents are not combined to form a cluster summary. If the summary type is a list/step-wise answer type, then step 348 is executed. A list or a step-wise answer may for example be a cooking recipe, in which case it is not desirable to combine sentences from multiple documents into a cluster summary.

At 344, a cluster summary is compiled by combining only the sentences of the answer set of sentences. Only sentences that have a high relevance are included in the cluster summary. At 350, an output of the cluster summary is provided. The cluster summary thus includes only sentences having the selected label that is selected at 322 and 334 that have been sorted at 336 and have been determined to be relevant at 340.

In addition to cluster summaries that are compiled according to method in steps 334 to 344, concept summaries are created according to the method in steps 352 to 356. At 352, the sentences in the sentence list are sorted into a sorted list of sentences by applying sort factors to the labels of the sentences in the sentence list. Note that all the sentences in the sentence list are sorted, also those that do not include the selected label that is selected at 322. The sort factors include:
1. The count of the current label (e.g., “poison ivy”) that is being evaluated; and
2. The freshness of each sentence which can be determined by a date that the sentence has been stored or a date of the document from which the sentence has originated.

At 354, an output is provided in response to the selected label that is selected at 322. The output includes the concepts and the concepts are based on the sorted list of sentences. In the present example, the concepts include “ivy plant,” “poison ivy rash,”, “three leaves,” “poison oak,” and “medical advice.” Each one of the concepts has the sentences that relate to the respective concept associated therewith and are provided as part of the output.

At 356, an output of a concept validation summary can be provided to a user. A concept validation summary includes selected ones of the sentences that match a selected one of the concepts.

Following steps 346, 348, 350 or 356, a determination is made at 360 whether all labels have been processed. If all labels have not been processed, then another label is selected at 322 and the process is repeated for the next label. If all the labels have been processed, then a determination is made at 362 that summary generation has been completed.

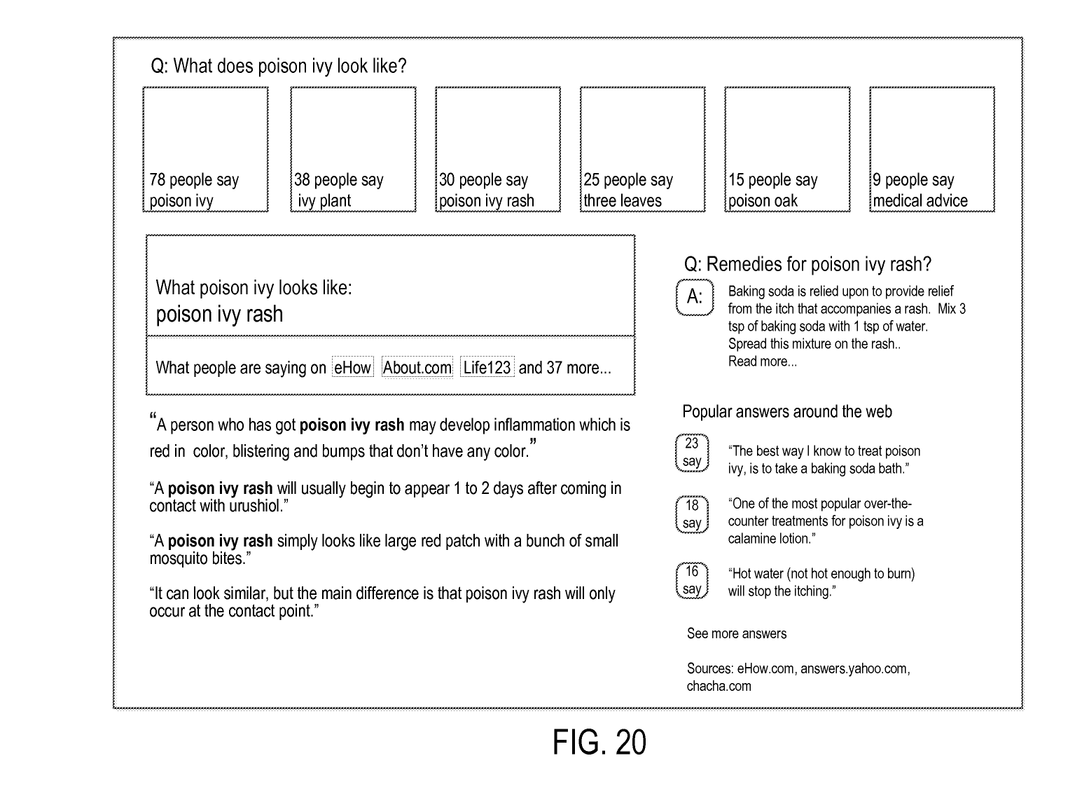

FIG. 20 illustrates a user interface that is displayed at a client computer system such as the client computer system 18 in FIG. 1. The user interface was originally in response to the query “What does poison ivy look like?” A number of concepts have been identified and are listed across the top. See step 354 in FIG. 19. On the right-hand side is a top answer. See step 348 in FIG. 19. When a user selects one of the concepts, in the present example “poison ivy rash,” then more details are provided for the concept in the bottom left-hand corner. See step 354 in FIG. 19.

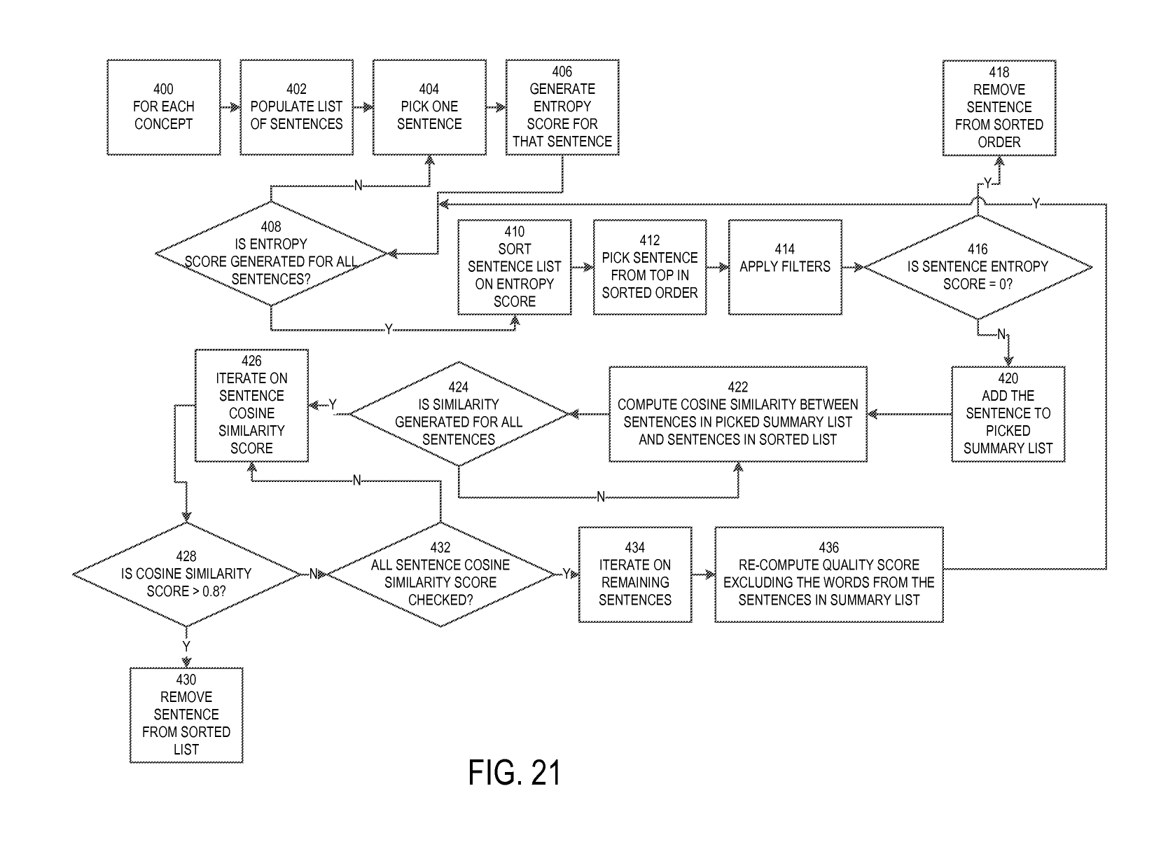

FIG. 21 illustrates relevance determination as hereinbefore described. At 400, each concept is isolated, as hereinbefore described. At 402, a list of sentences is populated for the respective concept, as hereinbefore described. The list of sentences is hereinafter referred to “the sentence list.”

At 404, the system picks one of the sentences in the sentence list. At 406, the system generates an entropy score for the respective sentence. The entropy score is generated using the following formula:

$$\begin{matrix}Entrpy score = {\sum }_{i = 1}^{n} P ( Wi \vert Sj ) \\ = sum of conditional probability distribution\end{matrix} \\ for every word in a sentence$$

Where, n=number of words in sentence Sj
   Therefore, conditional probability distribution (for every word in a sentence)=P(W|S)=P(Wi|Sj)*P(Sj). This entropy score indicates the number of unique words that are in the respective sentence. The higher the number of unique words, the higher the entropy score.

At 408, a determination is made as to whether an entropy score has been generated for all sentences in the sentence list. If an entropy score has not been generated for all sentences in the sentence list, then the system returns to 404 and repeats the selection of a respective sentence from the sentence list for which an entropy score has not been generated. The sentences that are selected are, for purposes of discussion, referred to “a first sentence” for which an entropy is generated.

If the determination at 408 is that an entropy score has been generate for all sentences in the sentence list, then the system proceeds to 410. At 410, the system sorts the sentence list based on the entropy scores of the respective sentences and obtains a “sorted order.”

At 412, the system picks each sentence from the top of the sorted order having the highest entropy score. At 414, the system applies certain filters to filter out sentences that do not look good, such as sentences that include the terms “$$,” “Age”, etc.

At 416, the system makes a determination as to whether the entropy score of each one of the sentences is above a pre-determined minimum entropy value. In the present example the pre-determined minimum entropy value is zero. If a sentence has an entropy score of zero, then the system proceeds to 418 wherein the sentence is removed from the sorted order created at 412. If the system determines that a sentence has an entropy value other than zero, i.e. an entropy value above zero, then the system proceeds to 412 wherein the sentence is added to a picked summary list. Each sentence in the picked summary list thus originated as a sentence previously defined as a “first sentence” in the sorted order created at 410. As previously mentioned at 412 the sentences are picked from the top of the sorted order and are then sorted at step 416. After all the sentences have been picked and sorted, sentence filtering based on entropy scores is completed for the time being.

Steps 422 to 434 now describe the process of removing any of the sentences in the sorted list created at 410 if they are similar to any of the sentences in the picked summary list created at 420. For purposes of further discussion, all the sentences in the picked summary list are referred to as “first sentences” and all the sentences that are in the sorted order are referred to as “second sentences.” A concept extracted at 400 may for example be all dogs that do not shed. The sentences in the picked summary list created at 420 may include one sentence with all the dog breeds that do not shed. If there is a sentence remaining in the sorted order created at 410 that includes names of the same breeds of dogs that do not shed, then that sentence is removed by following steps 422 to 434.

At 422, the system computes a cosine similarity score between sentences (first sentences) in the picked summary list (created at 420) and sentences (second sentences) in the sorted list (created at 410). At 424, the system determines whether similarity scores are generated for all the sentences in the picked summary list. If a similarity score has not been generated for all sentences in the picked summary list, then the system returns to 422 and repeats the computing of the cosine similarity score for the next sentence in the picked summary list. If the system determines at 424 that a similarity score has been generated for all sentences in the picked summary list, then the system proceeds to 426.

At 426, the system initiates a loop that follows via step 428 and returns via step 432 to step 426. At 426, the system iterates on system cosine similarity score. At 428, the system determines whether the cosine similarity score is above a pre-determined minimum similarity value of, in the present example 0.8. If the system determines at 428 that the similarity score is above the pre-determined minimum similarity value, then the system proceeds to 430 wherein the system removes the sentence (the second sentence) from the sorted order created at 410. If the system determines at 428 that the similarity score is not above the pre-determined minimum similarity score, then the system proceeds to 432. At 432, the system determines whether a similarity score for all sentences in the picked summary list have been checked. If a similarity score has not been checked for all sentences in the picked summary list, then the system returns to 426 and repeats the determination of whether a similarity score is above a pre-determined minimum similarity score for the next sentences in the picked summary list that has not been checked. The system will continue to loop through steps 426, 428 and 432 until a similarity score for each one of the sentences in the picked summary list has been checked and all sentences in the sorted order created at 410 that are similar to sentences in the picked summary list created at 412 have been removed from the sorted order.

At 434, the system proceeds to iterate on the remaining sentences that are in the sorted list. At 436, the system first removes words of the sentences (first sentences) that have made their way into the picked summary list created at 420 from words in the sentences in the sorted order created at 410. For example, if one of the sentences includes the names of five dog breeds that do no shed, then all the words in the sorted order corresponding to the five dog breeds that do not shed are removed. If there is a sentence that includes those five dog breeds and a sixth dog breed, then the sixth dog breed will be retained for further analysis. In addition, if any of the sentences in the picked summary list include filler words such as “the,” “a,” etc. then those words are also removed from the sentences in the sorted order created at 410.

At 436, the system further proceeds to generate an entropy score for each sentence in the sorted order after the words have been removed. The sorted order then becomes the list of sentences generated at 402. The system then proceeds to 404 wherein one of the sentences in the sentence list is selected. The system then repeats the process as described with reference to steps 404 to 420 to again create a picked summary list based on the remaining sentences in the sentence list after some of them have been removed at step 430 and words that have been removed at step 436.

The loop that is created following step 436 is repeated until a determination is made at 416 that are no more sentences in the sorted order or that all remaining sentences in the sorted order have an entropy score of zero. The remaining sentences in the picked summary list are what are determined to be relevant.

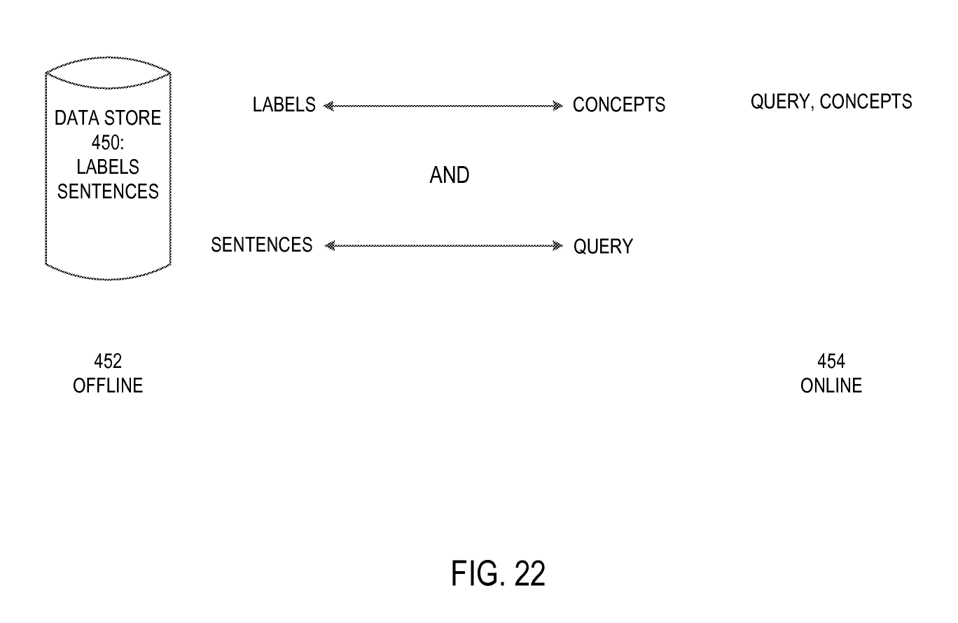

FIG. 22 illustrates data extraction for purposes of providing sentences to a consumer. The labels and sentences that are relevant are stored in a data store 450. The labels and sentences are created as hereinbefore described in an offline process 452 of concept generation, labeling, sentence identification, sentence relevancy determination and summary generation. A query is received in an online process 454. Based on the query concepts are determined as hereinbefore described. The relevant sentences and summaries in the data store 450 are determined by matching the labels in the data store 450 to the concepts that are determined based on the query. The relevant sentences are also determined by matching the sentences in the data store 450 with the query. Only sentences wherein both the labels are matched to the concepts and the sentences are matched to the query are extracted for purposes of providing back to a client computer system.

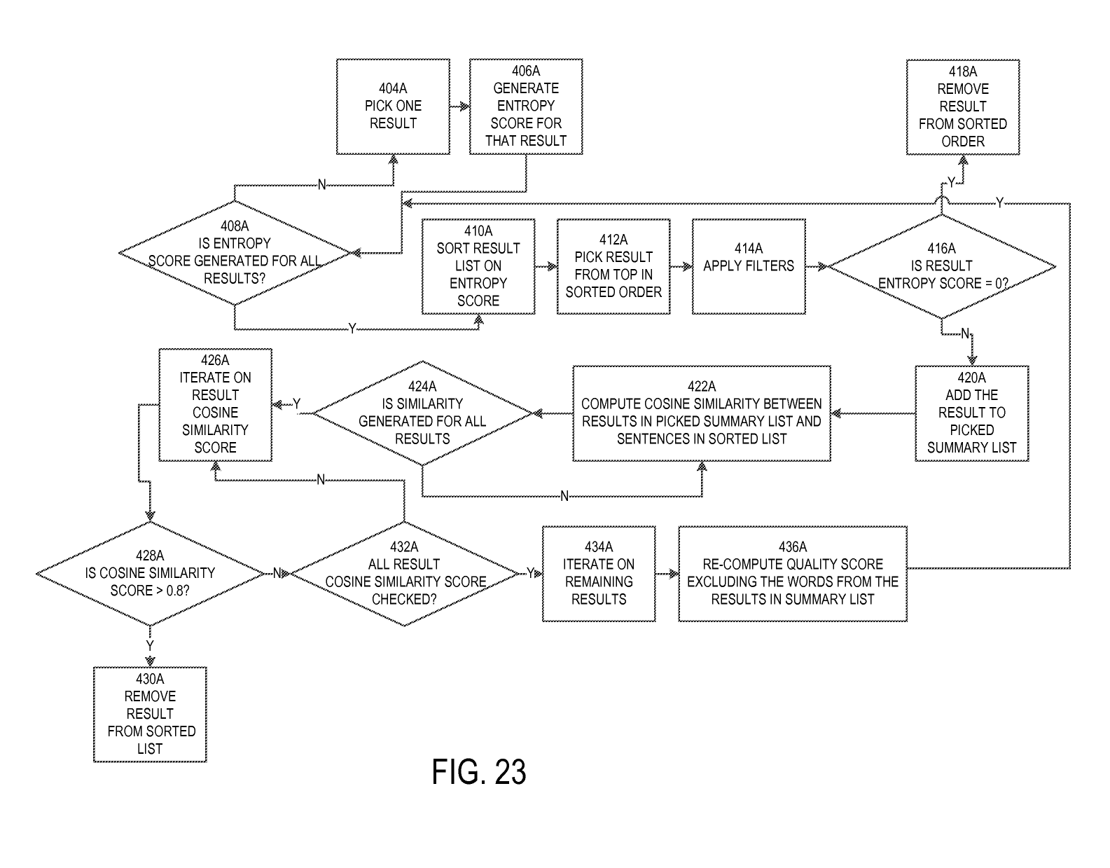

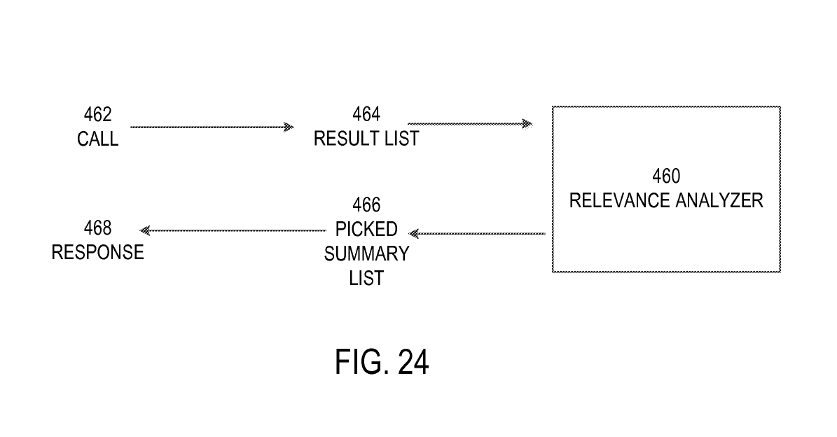

FIG. 23 illustrates how the relevance determinator of FIG. 21 can be used for other purposes. FIG. 23 is identical to FIG. 21 accept that “sentences” have been replaced with “results.” Like reference numerals indicate like or similar processes. In FIG. 24 a relevance analyzer 460 is shown which executes the processes as shown in FIG. 23. At 462, a call is received that includes a result list 464. The result list 464 may for example be a number of search results that are extracted from a data store based on a query. The relevance analyzer 460 then proceeds at step 404A in FIG. 23. After processing by the relevance analyzer 460, the relevance analyzer 460 provides a picked summary list 466 as a response 468 to the call 462.

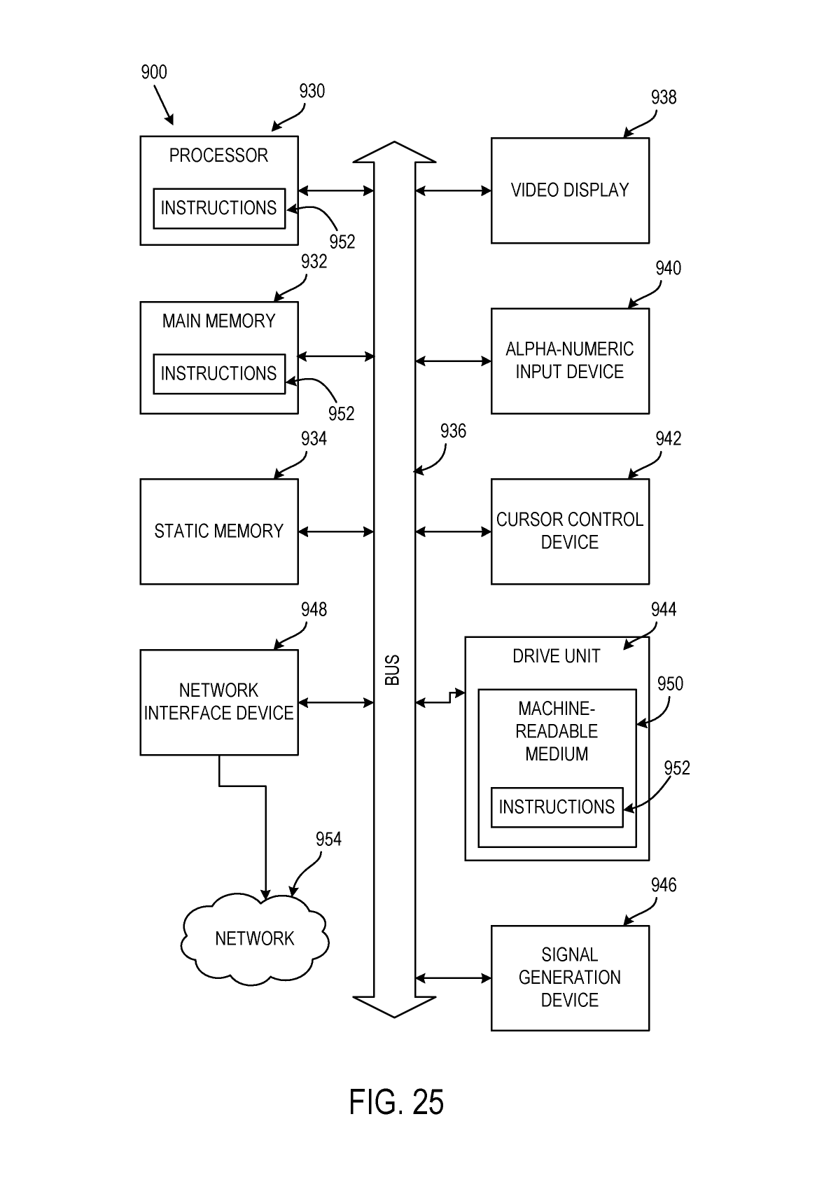

FIG. 25 shows a diagrammatic representation of a machine in the exemplary form of a computer system 900 within which a set of instructions, for causing the machine to perform any one or more of the methodologies discussed herein, may be executed. In alternative embodiments, the machine operates as a standalone device or may be connected (e.g., networked) to other machines. In a network deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 900 includes a processor 930 (e.g., a central processing unit (CPU), a graphics processing unit (GPU), or both), a main memory 932 (e.g., read-only memory (ROM), flash memory, dynamic random access memory (DRAM) such as synchronous DRAM (SDRAM) or Rambus DRAM (RDRAM), etc.), and a static memory 934 (e.g., flash memory, static random access memory (SRAM, etc.), which communicate with each other via a bus 936.

The computer system 900 may further include a video display 938 (e.g., a liquid crystal display (LCD) or a cathode ray tube (CRT)). The computer system 900 also includes an alpha-numeric input device 940 (e.g., a keyboard), a cursor control device 942 (e.g., a mouse), a disk drive unit 944, a signal generation device 946 (e.g., a speaker), and a network interface device 948.

The disk drive unit 944 includes a machine-readable medium 950 on which is stored one or more sets of instructions 952 (e.g., software) embodying any one or more of the methodologies or functions described herein. The software may also reside, completely or at least partially, within the main memory 932 and/or within the processor 930 during execution thereof by the computer system 900, the memory 932 and the processor 930 also constituting machine readable media. The software may further be transmitted or received over a network 954 via the network interface device 948.

While the instructions 952 are shown in an exemplary embodiment to be on a single medium, the term “machine-readable medium” should be taken to understand a single medium or multiple media (e.g., a centralized or distributed database or data source and/or associated caches and servers) that store the one or more sets of instructions. The term “machine-readable medium” shall also be taken to include any medium that is capable of storing, encoding, or carrying a set of instructions for execution by the machine and that cause the machine to perform any one or more of the methodologies of the present invention. The term “machine-readable medium” shall accordingly be taken to include, but not be limited to, solid-state memories and optical and magnetic media.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

1. A method of processing data comprising:
storing a set of documents in a data store; and
generating a hierarchical data structure based on concepts within the documents.

2. The method of claim 1, wherein the hierarchical data structure is generated according to a method comprising:
generating phrases from the documents;
initiating clustering of the phrases by entering respective documents into each of a plurality of slots, wherein only one documents is entered from multiple documents that are similar;
clustering the documents of each slot by creating tree with respective nodes representing the documents that are similar; and
labeling each tree by determining a concept of each tree.

3. The method of claim 2, wherein the phrases include at least uni-grams, bi-grams and tri-grams.

4. The method of claim 2, wherein the phrases are extracted from text in the documents.

5. The method of claim 2, further comprising:
expanding a number of the slots when all the slots are full.

6. The method of claim 2, wherein the clustering of the documents comprises:
determining whether a document is to be added to an existing cluster;
if the document is to be added to a new cluster, creating a new node representing the document;
following the creation of the new node, determining whether the new node should be added as a child node;
if the determination is made that the new document should be added as a child node, connecting the document as a child of the parent;
if the determination is made that the new node should not be added as a child node, swapping the parent and child nodes;
if the determination is made that the new document should not be added to an existing cluster, then creating a new cluster;
following the connection to the parent, the swapping of the parent and child nodes, or the creation of the new cluster, making a determination whether all documents have been updated;
if all documents have not been updated, then picking a new document for clustering; and
if a determination is made that all documents are updated, then making a determination that an update of the documents is completed.

7. The method of claim 2, wherein the clustering includes determining a significance of each one of the trees.

8. The method of claim 2, wherein the clustering includes:
traversing a tree from its root;
removing a node from the tree;
determining whether a parent without a sub-tree that includes the node has a score that is significantly less than a score of the tree before the sub-tree is removed;
if the determination is made that the score is not significantly less, then adding the sub-tree back to the tree;
if the determination is made that the score is significantly less, then dropping the sub-tree that includes the node;
after the node has been added back or after dropping the sub-tree, determining whether all nodes of the tree have been processed;
if all the nodes of the trees have not been processed, then removing another node from the tree and repeating the process of determining a significance; and
if all nodes have been processed, then making a determination that pruning is completed.

9. The method of claim 2, wherein the clustering includes iteratively repeating the creation of the trees and pruning of the trees.

10. The method of claim 2, wherein the labeling of each tree comprises:
traversing through a cluster for the tree;
computing a cluster confidence score for the cluster;
determining whether the confidence score is lower than a threshold;
if the confidence score is less than the threshold, then renaming a label for the cluster; and
if the confidence score is not lower than the threshold, then making a determination that scoring is completed.

11. The method of claim 10, wherein the confidence score is based on the following five factors:
a number of different sources that are included within the cluster;
a length of the maximum sentence;
a number of different domains; and
an order of ranking within the search engine database 180; and
a number of occurrences.

12. The method of claim 2, wherein the labeling further comprises:
traversing nodes of each tree comprising a cluster;
identifying a node label for each node;
comparing the node label with a parent label of a parent node in the tree for the cluster;
determining whether the parent label is the same as the node label;
if the determination is made that the parent label is not the same as the label for the node, then again identifying a node label for the node; and
if the determination is made that the parent label is the same as the node label, then making a determination that labeling is completed.

13. The method of claim 1, further comprising:
receiving a query from a user computer system, wherein the generation of the hierarchical data structure is based on the query; and
returning documents to the user computer system based on the hierarchical data structure.

14. A computer-readable medium having stored thereon a set of data which, when executed by a processor of a computer executes a method of processing data comprising:
storing a set of documents in a data store; and
generating a hierarchical data structure based on concepts within the documents.

15-67. (canceled)
